(19) United States
(12) Patent Application Publication
(10) Pub. No.: US 2026/0321968 A1
(43) Pub. Date: Oct. 15, 2026

(54) VEHICULAR RADAR SENSOR WITH ANTENNA DESIGN OPTIMIZED FOR IN-CABIN MONITORING

(71) Applicant: Magna Electronics Inc., Auburn Hills, MI (US)

(72) Inventors: Adarsh Madhukumaran, Kerala (IN); Usham V. Dias, Goa (IN)

(21) Appl. No.: 19/641,731

(22) Filed: Apr. 8, 2026

Related U.S. Application Data
(60) Provisional application No. 63/785,779, filed on Apr. 9, 2025.
(60) Provisional application No. 63/863,883, filed on Aug. 14, 2025.

(51) Int. Cl. H01Q 1/32; G01S 13/34; H01Q 25/00

(52) U.S. Cl. CPC H01Q 1/3233; G01S 13/34; H01Q 1/3291; H01Q 25/002

(57) ABSTRACT

A method includes receiving input constraints that includes a number of transmitter elements, a number of receiver elements, and a defined field of sensing. The method includes defining a cost function based on at least one coverage parameter. The at least one coverage parameter defines a sidelobe level (SLL) threshold across a plurality of non-boresight target locations within the defined field of sensing. The method includes executing an automated optimization algorithm to determine spatial coordinates for the transmitter elements and the receiver elements to minimize the cost function. The method includes generating a machine-readable hardware design specification for the vehicular cabin radar sensor. The hardware design specification defines a physical placement of the transmitter elements and the receiver elements on a printed circuit board based on the determined spatial coordinates.

### CROSS REFERENCE TO RELATED APPLICATION

The present application claims priority of U.S. provisional application Ser. No. 63/863,883, filed Aug. 14, 2025 and U.S. provisional application Ser. No. 63/785,779, filed Apr. 9, 2025, which are hereby incorporated herein by reference in their entireties.

### TECHNICAL FIELD

The present invention relates generally to a vehicular cabin monitoring system for a vehicle and, more particularly, to a vehicular cabin monitoring system that utilizes one or more radar sensors at a vehicle.

### BACKGROUND

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY

A computer-implemented method for determining an optimized antenna layout for a vehicular cabin radar sensor includes receiving input constraints that includes a number of transmitter elements, a number of receiver elements, and a defined field of sensing. The method includes defining a cost function based on at least one coverage parameter. The at least one coverage parameter defines a sidelobe level (SLL) threshold across a plurality of non-boresight target locations within the defined field of sensing. The method includes executing an automated optimization algorithm to determine spatial coordinates for the transmitter elements and the receiver elements. The automated optimization algorithm is configured to minimize the cost function. The method includes generating a machine-readable hardware design specification for the vehicular cabin radar sensor. The hardware design specification defines a physical placement of the transmitter elements and the receiver elements on a printed circuit board based on the determined spatial coordinates.

These and other objects, advantages, purposes and features of the present invention will become apparent upon review of the following specification in conjunction with the drawings.

### BRIEF DESCRIPTION OF THE DRAWINGS

FIG. 1 is a side view of a vehicle having a vehicular cabin monitoring system;

FIG. 2 is a schematic view of a radar sensor of the vehicular cabin monitoring system;

FIGS. 3 and 4 show spherical coordinate systems for measuring position of objects relative to the radar sensor;

FIGS. 5A and 5B show S-parameters of antenna elements of the radar sensor;

FIG. 6 shows the maximum coupling of Tx-Rx elements;

FIGS. 7A and 7B show azimuth beamwidth and elevation beamwidth;

FIGS. 8A and 8B show major and minor beamwidth of the antenna of the radar sensor;

FIGS. 9A and 9B show a beamformer response for the antenna of the radar sensor;

FIGS. 10A and 10B show sidelobe levels for the antenna of the radar sensor;

FIGS. 11A and 11B show positioning of the sidelobes for the antenna of the radar sensor;

FIG. 12 shows a count of sidelobes exceeding an SLL acceptance threshold;

FIG. 13 is a table of example parameters for the brute-force approach for determining antenna layout;

FIG. 14 shows different cost functions used for optimization;

FIG. 15 shows range variation due to breathing;

FIG. 16 shows example range information;

FIG. 17 shows parameters of an antenna optimized for child protection detection (CPD) using a brute force approach;

FIG. 18 shows coverage evaluation parameters of the antenna of FIG. 17;

FIG. 19 shows parameters of an antenna optimized for multi-occupant detection (MOD) using a brute force approach;

FIG. 20 shows coverage evaluation parameters of the antenna of FIG. 19;

FIG. 21 shows performance analysis of particle swarm optimization (PSO);

FIG. 22 shows performance analysis of genetic algorithm (GA) optimization;

FIG. 23 shows parameters of an antenna optimized for CPD using GA optimization;

FIG. 24 shows coverage evaluation parameters of the antenna of FIG. 23;

FIG. 25 is a table including evaluation parameters of the antenna of FIG. 23;

FIG. 26 shows parameters of an antenna optimized for MOD using GA optimization;

FIG. 27 shows coverage evaluation parameters of the antenna of FIG. 26;

FIG. 28 is a table including evaluation parameters of the antenna of FIG. 26;

FIG. 29 shows parameters of an antenna optimized for CPD and MOD using GA optimization;

FIG. 30 shows coverage evaluation parameters of the antenna of FIG. 29;

FIG. 31 is a table comparing performance of antenna geometry for different requirements;

FIG. 32 shows a first example optimized antenna geometry with a finer grid;

FIG. 33 shows coverage parameters for the antenna geometry of FIG. 32;

FIG. 34 shows a second example optimized antenna geometry with a finer grid;

FIG. 35 shows coverage parameters for the antenna geometry of FIG. 34;

FIG. 36 shows a third example optimized antenna geometry with a finer grid;

FIG. 37 shows coverage parameters for the antenna geometry of FIG. 36;

FIG. 38 is a table comparing performance of the antenna geometry of FIGS. 32, 34 and 36 for different space constraints;

FIG. 39 is a flowchart of synthetic target simulation;

FIGS. 40A and 40B show angle performance analysis for the antenna geometry of FIG. 32;

FIGS. 41A and 41B show angle performance analysis for the antenna geometry of FIG. 34;

FIGS. 42A and 42B show angle performance analysis for the antenna geometry of FIG. 36;

FIG. 43 is a flowchart of an example arrangement of operations for a method of determining an optimized antenna layout for the radar sensor of the vehicular cabin monitoring system;

FIG. 44 shows example jitter parameters for optimizing the antenna layout;

FIG. 45 shows an example switching strategy for optimizing the antenna layout;

FIGS. 46A-46C show a virtual array patten, a first array, and a second array in terms of distances between elements as determined or optimized using the brute force method for CPD operation;

FIGS. 47A-47C show a virtual array patten, a first array, and a second array in terms of distances between elements as determined or optimized using the brute force method for MOD operation;

FIGS. 48A-48C show a virtual array patten, a first array, and a second array in terms of distances between elements as determined or optimized using the GA method for CPD operation;

FIGS. 49A-49C show a virtual array patten, a first array, and a second array in terms of distances between elements as determined or optimized using the GA method for MOD operation;

FIGS. 50A-50C show a virtual array patten, a first array, and a second array in terms of distances between elements as determined or optimized using the MOGA method for CPD-MOD operation;

FIGS. 51A-51C show a virtual array patten, a first array, and a second array in terms of distances between elements as determined or optimized using the MOGA method with a finer grid for CPD operation;

FIGS. 52A-52C show a virtual array patten, a first array, and a second array in terms of distances between elements as determined or optimized using the MOGA method with a finer grid for MOD operation;

FIGS. 53A-53C show a virtual array patten, a first array, and a second array in terms of distances between elements as determined or optimized using the MOGA method with a finer grid for CPD-MOD operation;

FIG. 54 shows that a pattern of the transceivers of the antenna is independent of the physical location of the transceivers at the antenna;

FIGS. 55A and 55B show that multiple transmitter and receiver antenna arrays may produce the same virtual array; and

FIG. 56 shows parameters of an antenna having a virtual array and optimized for MOD using the brute force approach.

### DETAILED DESCRIPTION

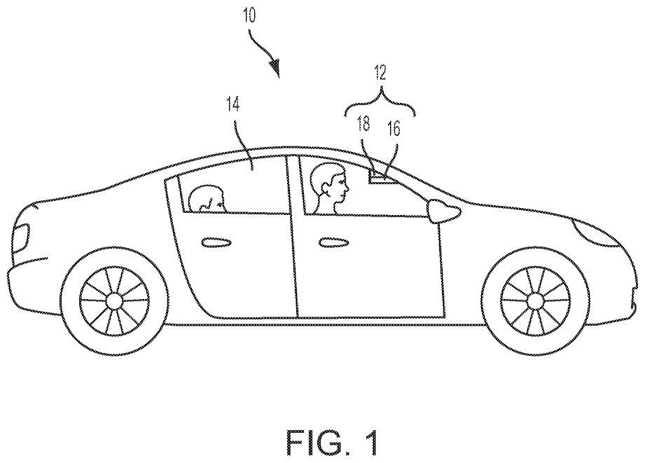

Referring now to the drawings and the illustrative embodiments depicted therein, a vehicular cabin monitoring system 12 for a vehicle 10 is configured to detect presence of occupants within the interior cabin 14 of the vehicle 10 (FIG. 1). For example, the system 12 may include one or more radar sensors 16 disposed at the interior cabin 14 of the vehicle 10 and that sense respective regions of the interior cabin 14 of the vehicle 10. The system 12 further includes a control or electronic control unit (ECU) 18 that includes electronic circuitry and associated software, such as a data processor or image processor for processing sensor data captured by the one or more sensors 16, whereby the ECU 18 may process sensor data captured by the one or more radar sensors 16 to detect presence of occupants, determine conditions of the occupants, and the like, as discussed further below. Although shown as disposed at an overhead console module of the vehicle 10, it should be understood that the one or more sensors 16 and/or the ECU 18 may be disposed at any suitable portion of the interior cabin 14 of the vehicle 10 for sensing regions of the interior cabin 14, such as at an interior rearview mirror assembly, a light module (e.g., a reading light or dome light), a grab handle module, and/or at or behind the vehicle headliner. The data transfer or signal communication from the one or more sensors 16 to the ECU 18 may comprise any suitable data or communication link, such as a vehicle network bus or the like of the equipped vehicle.

In-cabin radar may act like the “eyes” of a vehicular cabin monitoring system, detecting people inside and understanding their positions in the vehicle cabin. However, just like human vision, the clarity and accuracy of what the system “sees” may depend on several factors, which are influenced by the capabilities of the sensor it uses. In radar systems, antennas serve as the sensing elements that enable the system to “see.” The cabin monitoring system may provide an efficient way to design and implement antennas for improved performance. The geometry of the antenna or the way the antennas are designed and arranged, directly impacts the following factors:

Resolution may refer to the sharpness of an image. The higher the resolution, the clearer and more detailed the image. In radar, good resolution depends on the antenna geometry, as it affects how well the system is able to distinguish between different targets. The system may distinguish between two people sitting close together (e.g., a parent holding a child). The system may detect small movements, like breathing or hand gestures. The system may accurately locate objects, reducing errors in safety features. Poor resolution may cause the radar to view a blurry mess and fail to differentiate between passengers, leading to incorrect alerts or missed detections.

The center of a processed signal or beam pattern may be bright or useful while dimmer edges may be referred to as sidelobes. Any object present in these sidelobes can cause interference and confusion. Bad sidelobes may cause false detections (e.g., the system may falsely sense that an empty seat is occupied) and reduce accuracy by adding interference to the system.

By having the right antenna geometry, the radar focuses only on what matters, making detection precise and reliable. In simple terms, good resolution makes sure the radar “sees” things clearly, while low sidelobes prevent the system from getting confused. Together, a radar antenna that provides high resolution and low sidelobes may ensure the system works accurately and reliably.

The performance of an in-cabin sensing system (ICS) heavily relies on the antenna layout. The right geometry ensures accurate detection and classification of occupants. Traditionally, parameters such as resolution and sidelobe levels (SLL) of a target at boresight are used for evaluation. However, these parameters alone may not provide a comprehensive assessment of the antenna's performance. There is a need to evaluate the antenna performance by considering targets at various angles in both azimuth (horizontal plane) and elevation (vertical plane) within the area of interest (also called as Field of View, FoV). In addition to these parameters, the proposed system introduces new evaluation metrics, such as coupling parameters and coverage parameters, to enhance the design assessment.

Given the vast search space for antenna layouts, exhaustive searches are impractical due to limited resources. Therefore, optimization techniques are employed to find the best layout efficiently. The techniques explored are Particle Swarm Optimization (PSO), Genetic Algorithm (GA) and Multi-Objective Genetic Algorithms (MOGA). Among these techniques, MOGA is selected as the preferred optimization method because it supports multi-objective optimization. This capability is crucial for balancing the various performance metrics and achieving an optimal antenna layout that meets all requirements. By combining traditional and newly introduced evaluation parameters with advanced optimization techniques, this idea aims to determine the optimal antenna layout for in-cabin sensing systems.

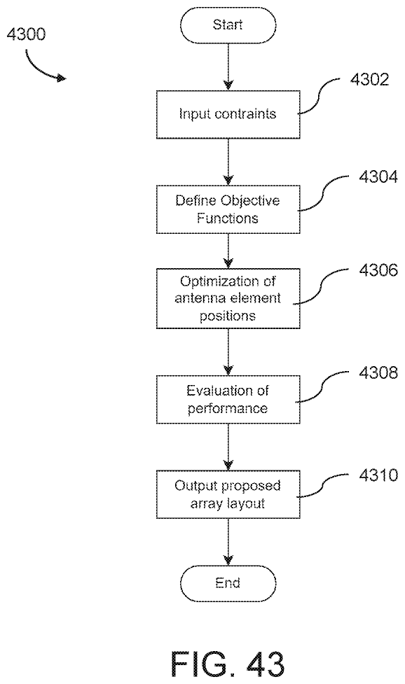

Thus, the vehicular cabin monitoring system includes a radar sensor with an antenna that transmits and/or receives signals to and/or from the cabin of the vehicle. The antenna includes geometry that is optimized to minimize sidelobe levels within a field of view or field of sensing that is at least ±70 degrees in azimuth and in elevation. The antenna may be optimized via an automated or computational optimization technique. For example, the antenna may be optimized using a brute force approach and/or further optimized via one or more of particle swarm optimization (PSO), genetic algorithm (GA) optimization, multi-objective genetic algorithms (MOGA) optimization, and the like, and as discussed further with respect to FIG. 43. The antenna may be optimized for child presence detection (CPD) and/or multi-occupant detection (MOD) functions.

Occupant detection using radar is a cutting-edge approach to enhance in-cabin safety and comfort in modern vehicles. Radar-based systems are designed to detect and monitor the presence, position, and movement of occupants within a vehicle, facilitating various safety and convenience applications such as Child Presence Detection and Seat Belt Reminder. Unlike traditional sensors, radar ensures reliable performance under varying environmental conditions. Frequency Modulated Continuous Wave (FMCW) radar is commonly employed for this purpose due to its high resolution and accuracy. However, the performance of radar systems can be impacted by the number of transmit (Tx) and receive (Rx) elements, which can limit the precision in locating occupants or identifying specific body parts—crucial for advanced safety features. The radar sensor described herein may include a suitable antenna layout for in-cabin applications, addressing challenges such as improving azimuth and elevation resolution, enhancing multi-occupant detection and localization, detecting weak targets in the presence of strong targets, and reducing false positives in the angle domain. By considering constraints such as the number of Tx/Rx elements, available space, and Field of View (FoV), the radar includes a custom antenna design to achieve higher resolution in the angle domain. This will enable radar systems to deliver more precise and detailed occupant detection, thereby enhancing the overall safety and functionality of in-cabin monitoring systems.

In modern automotive systems, radar-based in-cabin sensing has emerged as a critical technology for enhancing safety, security, and user experience. These systems leverage millimeter-wave (mmWave) radar to detect occupant presence, monitor vital signs, track movements, and ensure compliance with safety regulations. The design of the antenna array plays a fundamental role in determining the system's performance, influencing parameters such as beamforming capability, resolution, coverage, and interference mitigation.

The cabin monitoring system performance depends on array topology and specific beamforming parameters. The system optimizes radiation pattern, gain, and directivity while ensuring compliance with automotive radar standards (e.g., 77 GHz ISM band). Additionally, factors such as placement constraints, coverage in angular domain and multi-user detection affect the robustness and accuracy of in-cabin monitoring applications.

By leveraging advanced signal processing and MIMO (Multiple-Input Multiple-Output) configurations, a well-designed antenna array can significantly improve detection accuracy, resolution, and system efficiency, paving the way for next-generation smart vehicles with enhanced occupant monitoring and safety features.

Good angular resolution of the in-cabin radar systems is crucial because it directly impacts the system's ability to accurately detect, localize, and identify the occupants within the vehicle. Child Presence Detection is the most critical application of in-cabin systems, as it is essential for preventing heatstroke-related fatalities, which are a significant risk when children are left in vehicles. Poor resolution in the angular domain can lead to wrong localization and increasing the chances of not detecting the child occupants who have been left behind.

NCAPs (new car assessment programs), such as Euro NCAP, have begun incorporating Child Presence Detection systems into their safety ratings. The presence and effectiveness of these systems can positively influence a vehicle's overall star rating, reflecting its enhanced child safety features. Localization errors in the system will directly impact the overall star rating, making vehicles less attractive to consumers.

The importance of having better resolution can be seen in the following ways. Correct occupant localization is achieved as improved angular resolution allows the system to more precisely localize occupants, which is crucial for safety features such as Seat Belt Reminders and airbag deployment. Multi-occupant detection with enhanced angular resolution enables the system to discriminate two or more occupants when they are seated close together. Occupant classification with better angular resolution allows the radar to capture more detailed information about the occupant's posture, movements, orientation, and the like. False positive suppression with improved angular resolution aids in suppressing clutter and distinguishing inanimate objects, reducing false positives.

If the angular resolution is insufficient for in-cabin applications, the following problems can occur. Inaccurate occupant detection as the system struggles to correctly localize occupants, especially when they are close together. Increased false positives (or false negatives) as poor angular resolution can lead to false detections or failures to detect occupants. Inability to do advanced safety features as some safety features such as seat belt reminder, airbag deployment, personalized climate control, etc., need accurate occupant detection. Increased system complexity as poor angular resolution leads to additional processing to get reliable results.

By utilizing millimeter-wave (mmWave) radar (typically operating at 60 GHz or 77 GHZ), radar-based in-cabin sensing systems may detect micro-movements, breathing patterns, heart rate, and even gestures with high precision. Unlike traditional optical or infrared-based sensors, radar is resilient to poor lighting conditions, obstructions, and privacy concerns, making it a reliable solution for applications such as child presence detection, driver monitoring, seatbelt reminders, and gesture-based controls. With the increasing adoption of ADAS (Advanced Driver Assistance Systems) and regulatory mandates for child presence detection (e.g., Euro NCAP and U.S. HOT CARS Act), in-cabin radar sensing is becoming a critical component of modern vehicle safety and automation.

A well-designed antenna array and signal processing architecture play a crucial role in enhancing the resolution, field of view, and detection accuracy of radar-based in-cabin sensing systems. Advanced techniques such as MIMO (Multiple-Input Multiple-Output) radar, beamforming, and AI-driven signal interpretation enable precise tracking of multiple occupants and their vital signs. As automotive radar technology continues to evolve, in-cabin sensing systems may leverage AI-driven fusion with other modalities (such as cameras and ultrasonic sensors) to offer enhanced situational awareness, personalized in-cabin experiences, and proactive safety interventions in next-generation smart vehicles.

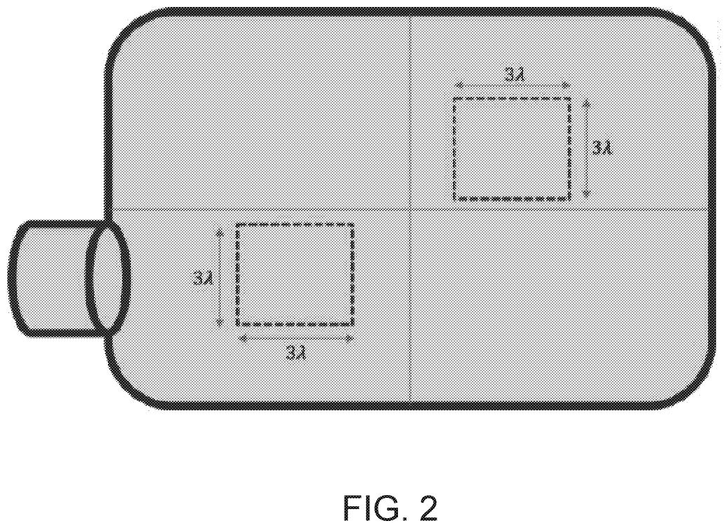

Constraints may govern the design and optimization of the antenna geometry for in-cabin radar sensing. These constraints ensure that the solution aligns with the physical and performance limitations of the system. The constraints include number of transmitting (Tx) elements (e.g., four), number of receiving (Rx) elements (e.g., four), Field of View (FoV) of Azimuth angle at ±70 degrees and Elevation angle at ±70 degrees, maximum available span for transmitter antenna placement along both the y direction and the z direction is 3λ, maximum available span for receiver antenna placement along both the y direction and the z direction is 3λ (FIG. 2), where λ represents the wavelength corresponding to the carrier wave frequency. These constraints serve as the foundation for designing and optimizing the antenna geometry to meet the requirements of in-cabin sensing. In general, other constraints may be used as a foundation depending on the requirements.

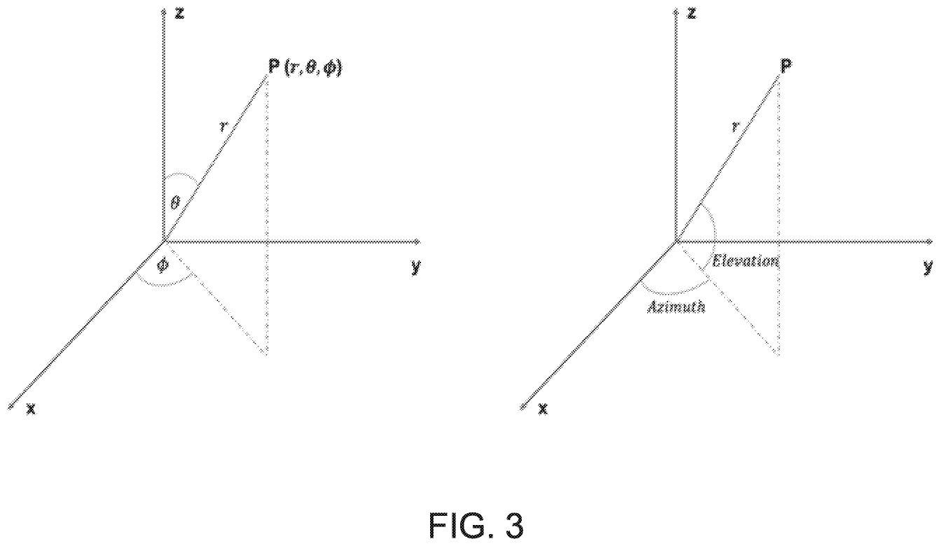

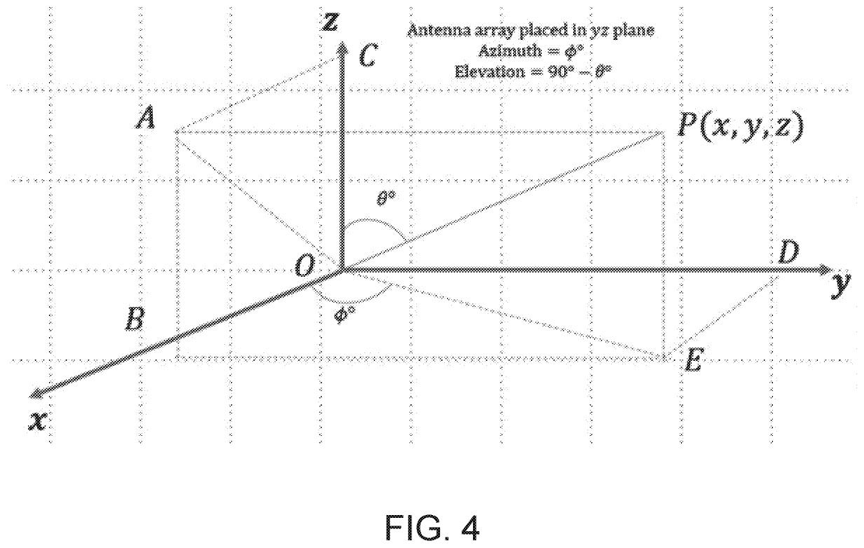

The spherical coordinate system defines a vector or point in space with a distance R and two angles, phi (φ) and theta (θ) angles or azimuth and elevation angles, as shown in FIGS. 3 and 4. As illustrated in FIG. 4, the φ angle is the angle from the positive x-axis to the vector's orthogonal projection onto the xy plane, moving in the direction towards the y-axis. The θ angle is the angle from the positive z-axis to the vector itself. These angles provide an alternative to using azimuth and elevation angles for expressing the location of a point on a unit sphere. Similarly, as shown in FIG. 3, the azimuth angle is the angle from the positive x-axis to the vector's orthogonal projection onto the xy plane, moving in the direction towards the y-axis. The elevation angle is the angle from the vector's orthogonal projection on the xy plane toward the positive z-axis, to the vector. This system may adhere to this definition of angles, where azimuth=φ and elevation=90 degrees minus θ.

The total number of transmit antenna elements is noted by M and the number of receive antenna elements is denoted by N. The coordinates of the transmit antennas in the y-axis and the z-axis are represented as:

$${y}_{{T}_{x}} = ( {y}_{1}^{( {T}_{x} )} , … , {y}_{M}^{( {T}_{x} )} )$$

$${z}_{{T}_{x}} = ( {z}_{1}^{( {T}_{x} )} , … , {z}_{M}^{( {T}_{x} )} )$$

Similarly, the positions of the receive antenna elements along the y-axis and the z-axis are given by:

$${y}_{{R}_{x}} = ( {y}_{1}^{( {R}_{x} )} , … , {y}_{N}^{( {R}_{x} )} )$$

$${z}_{{R}_{x}} = ( {z}_{1}^{( R )} , … , {z}_{N}^{( {R}_{x} )} )$$

In a multistatic 2D-MIMO radar configuration, each unique combination of a transmitter and a receiver creates a virtual antenna element. With M transmitters and N receivers, a total of M×N virtual elements are formed. The y-coordinate and the z-coordinate of the virtual array elements are given by:

$${y}_{virt} = ( \begin{matrix}{y}_{1}^{( {T}_{x} )} + {y}_{1}^{( {R}_{x} )} \\ ⋮ \\ {y}_{1}^{( {T}_{x} )} + {y}_{N}^{( {R}_{x} )} \\ ⋮ \\ {y}_{M}^{( {T}_{x} )} + {y}_{1}^{( {R}_{x} )} \\ ⋮ \\ {y}_{M}^{( {T}_{x} )} + {y}_{N}^{( {R}_{x} )}\end{matrix} ) , {z}_{virt} = ( \begin{matrix}{z}_{1}^{( {T}_{x} )} + {z}_{1}^{( {R}_{x} )} \\ ⋮ \\ {z}_{1}^{( {T}_{x} )} + {z}_{N}^{( {R}_{x} )} \\ ⋮ \\ {z}_{M}^{( {T}_{x} )} + {z}_{1}^{( {R}_{x} )} \\ ⋮ \\ {z}_{M}^{( {T}_{x} )} + {z}_{N}^{( {R}_{x} )}\end{matrix} )$$

Referring to FIG. 4, consider ∠POC=θ, BOE=φ, OP=r and P (x, y, z) is the target location. From the right triangle P OE, OE=r sin θ. Hence, OB=OE cos φ=r sin θ cos φ, OD=r sin θ sin φ and PE=r cos θ.

Path difference is derived from the dot product of the position vector of any point in space is P (r sin θ cos φ, r sin θ cos φ, r cos θ) in the direction of interest with the position vector of the element. Path difference of the signal when it reaches the mn^{th} element is given by αₘₙ=O^{→}P. ^{→}rₘₙ. As ^{→}rₘₙ=ndj+mdk, where j and k are the unit vectors in the y and z directions, respectively. Hence, αₘₙ=nd sin θ sin φ+md cos θ and delay is,

$$τ = \frac{nd sin θsinϕ + md cos θ}{c}$$

The received signal at mn^{th} element is,

$${x}_{mn} ( t ) = {\sum }_{p = 0}^{p} {S}_{mn}^{p} ( t ) + {w}_{mn} ( t )$$

where m,n=0, 1, 2, 3, . . . and wₘₙ(t) is assumed to be White Gaussian noise. Further assuming far field for targets and narrow band signal and hence the approximation for p^{th} target is s^{P}(t)~e^{j2πf}_{c}(t⁻¹ₘₙ). So the delay and sum beamformer output is,

$$y ( t ) = {\sum }_{m = 0}^{M - 1} {\sum }_{n = 0}^{N - 1} {x}_{mn} ( t - {τ}_{mn} )$$

Assuming zero noise,

$$y ( t ) = {\sum }_{m = 0}^{M - 1} {\sum }_{n = 0}^{N - 1} {e}^{j 2 π {f}_{c} ( t + {τ}_{mn}^{p} - {τ}_{mn} )} = {e}^{j 2 π {f}_{c} t} {\sum }_{m = 0}^{M - 1} {\sum }_{n = 0}^{N - 1} {e}^{j 2 π {f}_{c} {τ}_{mn}^{p}} {e}^{- j 2 π {f}_{c} {τ}_{mn}}$$

For example, radar-based non-contact vital sign monitoring may be achieved using various radar technologies, including UWB, CW Doppler radar, and FMCW. While these methods perform effectively under controlled conditions, several challenges must be addressed to enhance their reliability and robustness for real-world applications. Challenges include mitigating the impact of body and sensor movement, suppressing breathing harmonics, and ensuring accurate measurements in cluttered environments. Overcoming these challenges typically requires advanced signal processing techniques, the integration of multiple radar systems, or the fusion of radar with other sensing modalities. Beyond vital sign monitoring, mmWave sensors have also shown potential for detecting drowsiness, stress levels, and human emotions. Additionally, the design of the radar antenna layout plays a critical role in determining the accuracy of estimated vital signs, further emphasizing the importance of optimized antenna configurations in such systems.

Techniques for external radar systems may be modified for in-cabin use. Most of the external radar applications demand better angular resolution in azimuth direction, whereas they don't require resolution in elevation direction. Unlike external radars, in-cabin systems may require equal importance to azimuth angle as well as elevation angle, even though it depends on the mounting of the radar inside car cabin. Numerous studies have shown that sparse signal reconstruction can enhance resolution without the need to increase the number of antennas.

For example, one method for assessing the performance of a 2-D MIMO radar system for 3D imaging, utilizes a detailed analysis of the ambiguity function. A strength of this method is its evaluation of the ambiguity function across the entire angular field of view, enabling the identification of interfering signals beyond the primary region of interest and thereby improving the reliability of the assessment. To enhance system performance, a genetic algorithm (GA) is implemented to optimize the design of a 2-D MIMO sparse array composed of four transmitters and eight receivers. The optimized antenna positions obtained through GA are then used to develop a 2-D MIMO radar array operating at 76.5 GHz. The results indicate a high degree of consistency between simulated and experimental measurements, validating the accuracy and robustness of the proposed method.

Another method may estimate the direction of arrival (DOA) in FMCW radar systems by employing sparse arrays and a least squares approach. The proposed algorithm offers several advantages, including direct applicability to broadband chirps and improved resolution and accuracy over traditional half-wavelength spaced uniform arrays due to the use of sparse arrays. Additionally, the sparse arrays are designed with interelement spacing significantly larger than half of wavelength, which substantially reduces mutual coupling effects.

Another method may investigate how the positions of antenna elements affect the target detection performance of a conventional 2Tx-4Rx FMCW MIMO radar. The method evaluates three different array layouts of minimum redundancy array, sparse array, and interleaved array and assesses their effectiveness in target detection for automotive radar applications.

S-parameters, or scattering parameters, are numerical values that characterize the electrical performance of a linear, time-invariant, multi-port network, such as an RF circuit or system. They define the relationship between incident and reflected waves at each port, offering a detailed insight into energy transfer within the system. These parameters are commonly expressed in an S-matrix, an N×N matrix where N is the number of network ports.

The S-parameters in antenna design may include reflection coefficients for Transmitter (Sᵢᵢ) and Receiver (Sⱼⱼ). This determines how well each antenna is impedance-matched to the system. A low Sᵢᵢ or Sⱼⱼ means minimal power reflection, leading to efficient signal transmission. Poor impedance matching results in power loss and affects radar performance.

The S-parameters may also include cross coupling between transmitter elements and receiver elements. This measures isolation between different transmitter elements as well as between different receiver elements. This helps evaluate antenna coupling, signal loss, and overall system efficiency. It may be useful for analyzing signal leakage and unwanted interference between transmitter elements and receiver elements. High isolation reduces interference and improves independent signal transmission.

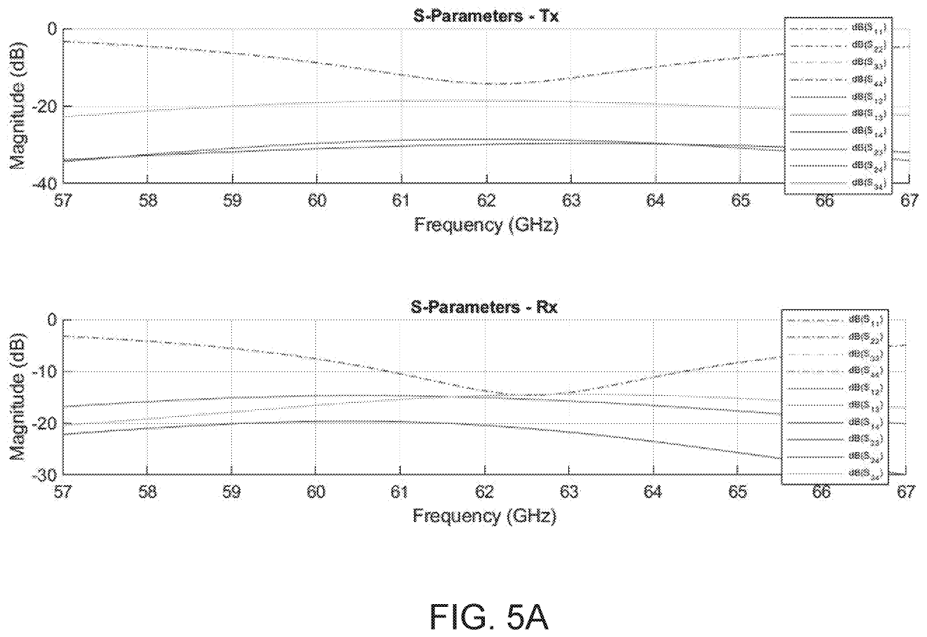

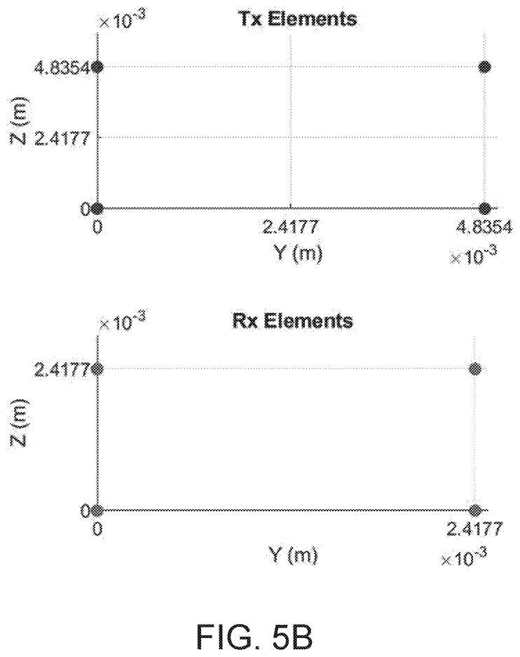

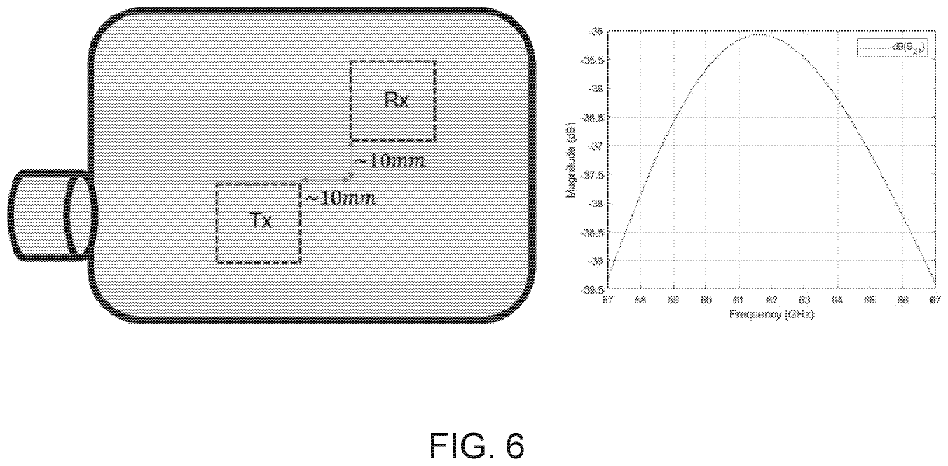

The S-parameters are inherently reciprocal, which implies that the S-parameters are the same when measuring the response from element i to element j or from element j to element i. The computed S-parameters for a given transmitter and receiver configuration across a range of frequencies are plotted in FIGS. 5A and 5B. If the mutual coupling between the transmit (Tₓ) and receive (Rₓ) elements is measured to be approximately-35 dB, at center frequency, as illustrated in FIG. 6, the effect is considered to be negligible and can thus be ignored in the system model. For instance, the separation between a Tₓ-Rₓ element is approximately 10 mm in the y direction and 10 mm in the z direction as shown in FIG. 6. Furthermore, positioning the Tₓ and Rₓ arrays in opposite or diagonal quadrants ensures greater separation between elements, thereby minimizing mutual coupling effects. Since the system intentionally neglects Tₓ-Rₓ mutual coupling, it is assumed that the antennas are arranged in diagonal quadrants (or in any configuration where the spacing between Tₓ and Rₓ elements is sufficiently large).

In 2D MIMO radar antenna systems, beamwidth parameters play a crucial role in determining the system's spatial resolution and target discrimination. Beamwidth defines the angular spread of an antenna's radiation pattern, affecting how well signals are transmitted and received in different directions. The beamwidth is typically measured at the half-power (−3 dB) points of the main lobe in the radiation pattern. A narrower beamwidth provides higher spatial resolution, allowing better discrimination between closely spaced objects or occupants. Further, antenna array design and element spacing influences the beamwidth. A narrow beam enables targeted transmission, improving signal-to-noise ratio (SNR) and reducing interference. This also improves data transmission by focusing energy towards specific occupants/targets. Narrower beamwidth antennas enhance directivity, ideal for high-capacity, long-range communication. A well-optimized beamwidth may reduce sidelobes, minimizing interference from unwanted signals.

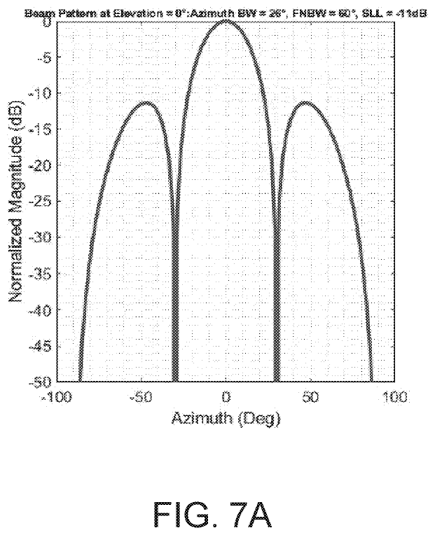

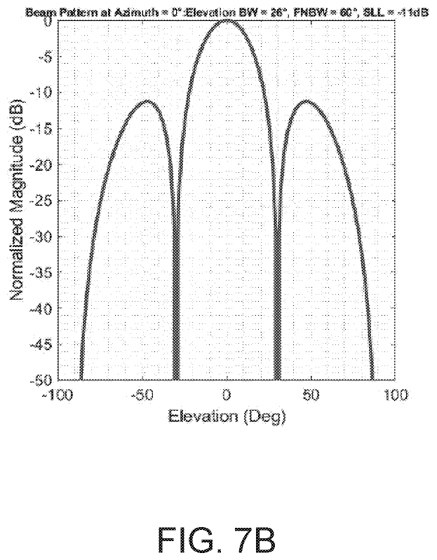

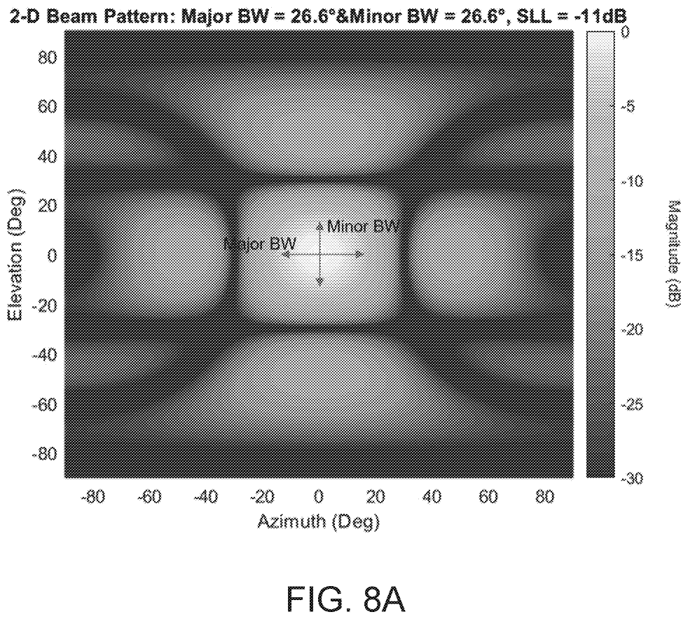

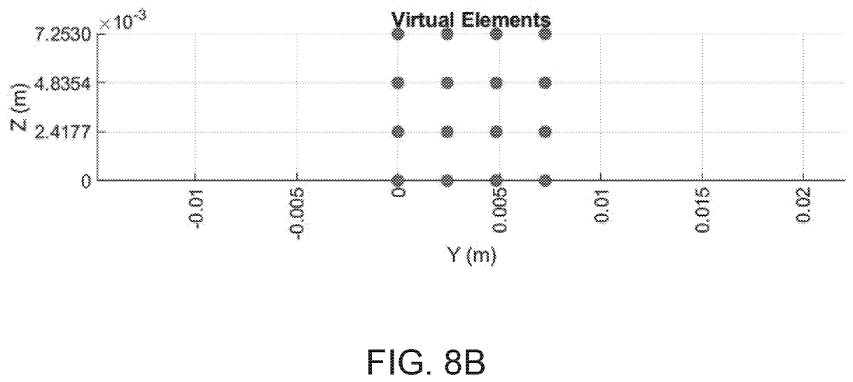

The beamwidth of an 2D MIMO antenna is typically divided into two components: major beamwidth and minor beamwidth, which refer to the angular spread of the main lobe in different planes. Azimuth beamwidth is typically measured in the azimuth (horizontal) plane, which determines the angular spread of the main lobe along the horizontal scanning direction (FIG. 7A). Elevation beamwidth is measured in the elevation (vertical) plane, affecting vertical coverage and detection capability (FIG. 7B). The major and minor beamwidth in FIGS. 8A and 8B refer to the angular spread of the main lobe in different planes, with the major beamwidth representing coarser resolution and the minor beamwidth representing the finer resolution.

Sidelobe level (SLL) is a critical parameter in antenna design that affects performance, interference control, and overall system efficiency. Sidelobes represent the unintended radiation in directions other than the main beam, often leading to signal degradation, interference, and reduced target detection accuracy. Managing sidelobe levels is particularly important in in-cabin sensing applications. Main lobe is defined as the primary radiation lobe where most of the energy is concentrated and sidelobes are the secondary radiation lobes that may appear on either side of the main lobe. Sidelobe Level (SLL) is the relative power level of the sidelobes compared to the main lobe, typically expressed in decibels (dB).

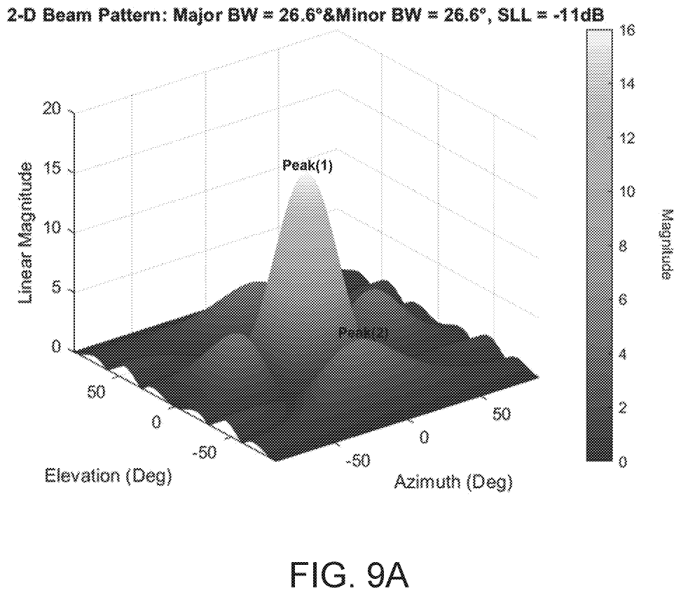

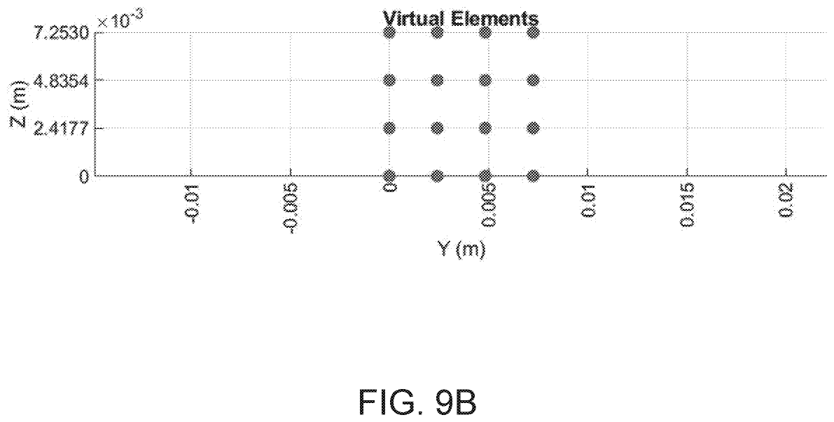

Considering the antenna layout in FIGS. 9A and 9B, Sidelobe level in dB from FIGS. 9A and 9B may be determined as,

$${SLL}_{dB} = 20 {log}_{10} ( \frac{peak ( 2 )}{peak ( 1 )} )$$

where peak (1) is the magnitude of maximum beam pattern value and peak (2) is the second highest peak of beam pattern. Low SLL improves detection accuracy and enhances target discrimination. High sidelobes may introduce false alarms due to unwanted signal leakage. Improved beamforming as controlling sidelobes ensures precise beam steering. Reducing sidelobe levels helps focus energy on desired directions, improving signal-to-noise ratio (SNR).

To ensure proper functionality of ICS, it is crucial to determine the coverage in both azimuth and elevation directions. The applications may require a ±70 degrees field of View (FoV) in both azimuth and elevation directions. The following approach outlines the method used to determine the coverage for a selected antenna layout.

Assumption of target positions. A single target is assumed to be present within the ±70 degrees range in both azimuth and elevation directions. The target positions may be considered with a step size of either 5 degrees or 10 degrees, resulting in a total of 29×29 or 15×15 target positions respectively.

Perform 2-Dimensional beamforming. For each target position, perform 2D beamforming which gives the beam pattern.

Sidelobe level determination. Measure the sidelobe level (SLL) in dB for each target position from the beam pattern. Compute the location of sidelobe in azimuth and elevation direction. Compute the number of significant sidelobes for each target locations.

Evaluation of coverage. Analyze the SLL values and their locations to determine the effectiveness of the antenna layout. Ensure that the SLL values are within acceptable limits to guarantee proper coverage.

By following this approach, not only can the boresight target be accurately determined, but also the wide angular coverage in both azimuth and elevation, ensuring that the ICS operates effectively within the required field of view.

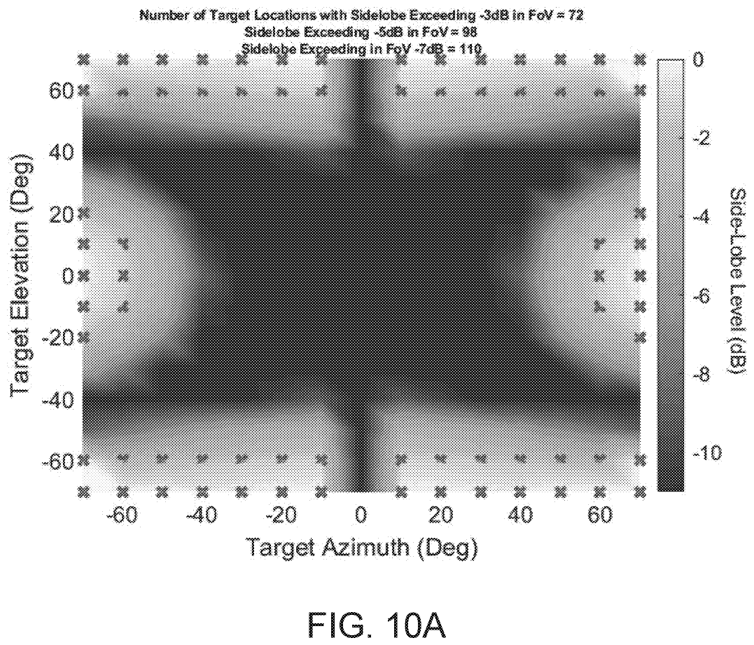

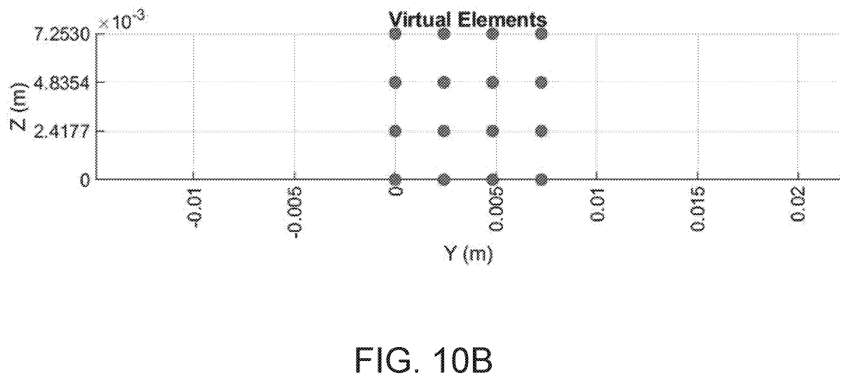

For example, consider the virtual element geometry shown in FIGS. 10A and 10B and an acceptance SLL threshold of −3 dB. This implies that if the SLL for a target at a given azimuth and elevation is below −3 dB, it is considered acceptable; otherwise, it is deemed unacceptable. This information is illustrated in FIGS. 10A and 10B, where the color or shading representation indicates the sidelobe level (SLL) in dB for a target located at a specific azimuth and elevation.

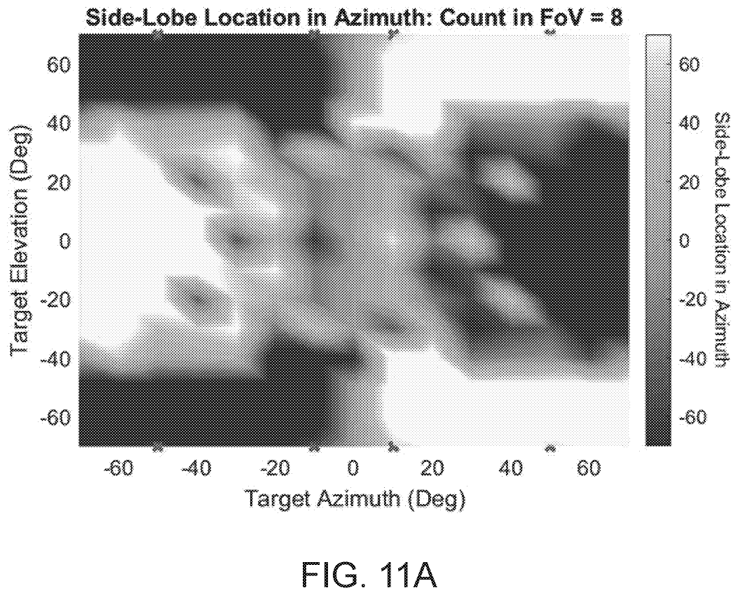

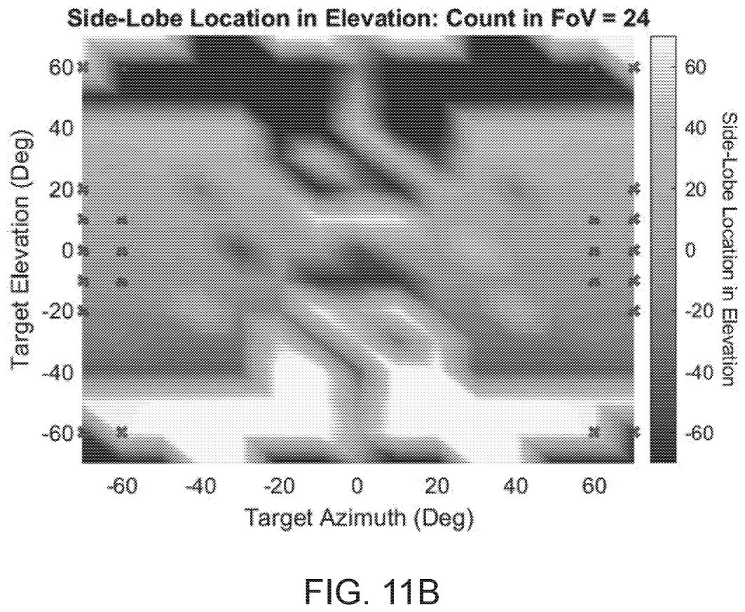

For target locations that do not meet the SLL acceptance criteria, it is essential to analyze the sidelobe position in both the azimuth and elevation directions. The azimuthal sidelobe locations are depicted in the graph of FIG. 11A, while the elevation sidelobe locations are shown in the graph of FIG. 11B. In these figures, color or shading representation indicates the sidelobe position for a target at a specific azimuth and elevation.

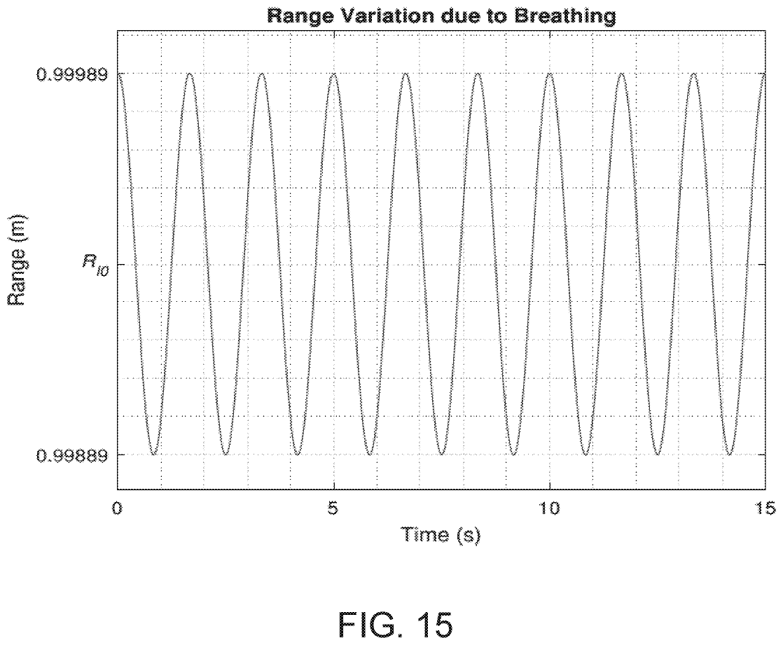

It is also crucial to consider the number of sidelobes that exceed the SLL acceptance criteria. This information is presented in FIGS. 10A and 10B, where the title indicates the number of sidelobes surpassing the SLL acceptance threshold. The obtained information is used to evaluate the effectiveness of the antenna virtual layout under consideration. One such evaluation is as follows. Counting target grid points with SLL greater than −3 dB. From FIGS. 10A and 10B, 15×15=225 target grid points are considered for evaluation. After performing the 2D beamforming and SLL analysis, there are 72 (lower the count, better the performance) out of 225 target points with SLL greater than −3 dB.

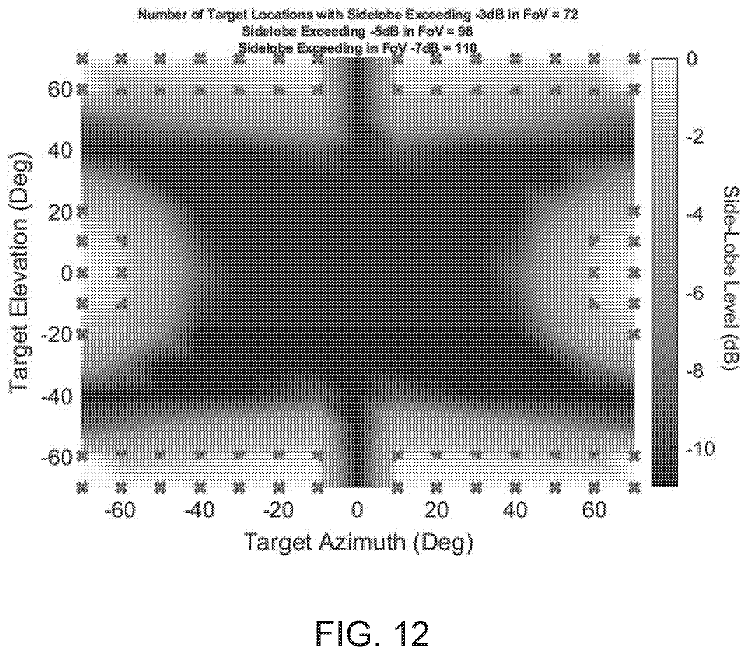

Identifying sidelobe locations. For the 72 points where SLL is greater than −3 dB, the sidelobe locations are analyzed. Out of these 72 points, from the graph of FIG. 11A, 8 (lower the count, better the performance) target points have sidelobe locations within ±70 degrees in azimuth. From the graph of FIG. 11B, 24 (lower the count, better the performance) target points have sidelobe locations within ±70 degrees in elevation. From FIG. 12, 24 (lower the count, better the performance) target points have more than one significant sidelobe.

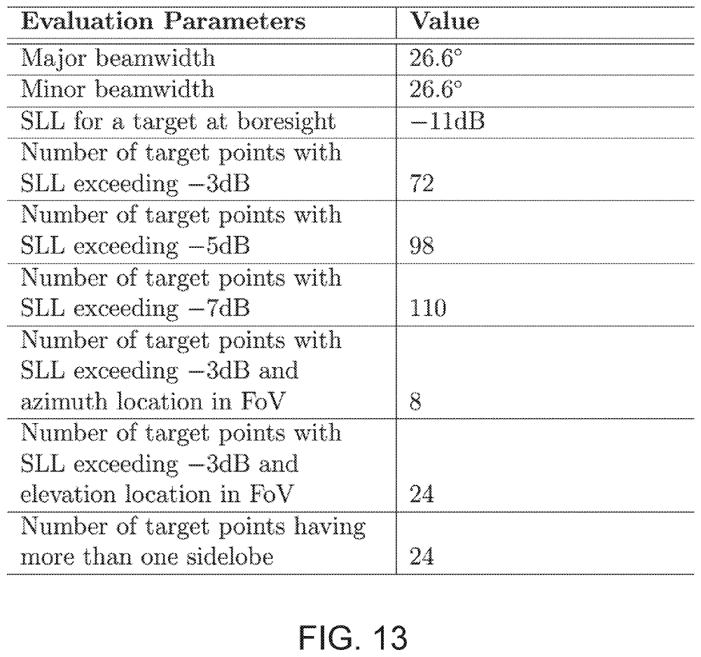

A brute-force approach for determining the best antenna layout involves systematically evaluating all possible configurations to identify the most optimal design. This method requires an exhaustive search, testing various arrangements of transmit (Tx) and receive (Rx) elements while analyzing performance metrics (e.g., in FIG. 13). The primary advantage of this approach is that it guarantees finding the globally optimal solution, as every possible configuration is explored without relying on approximations or heuristics. However, the brute-force method becomes computationally expensive as the number of elements increases. The search space grows exponentially, making it infeasible for large-scale antenna arrays, especially in applications like MIMO radar or phased arrays, where numerous elements need to be optimized. Additionally, evaluating each layout requires performing extensive simulations, which can be time-consuming. Despite these challenges, brute-force evaluation serves as an excellent bench-marking tool, helping validate results obtained from more efficient optimization techniques, such as genetic algorithms, machine learning-based approaches, or iterative heuristics. In scenarios where computational resources are available, brute-force searching can be valuable in determining the theoretical upper limit of performance, refining design constraints, and gaining insights into antenna behavior under different configurations.

While the brute-force approach provides a comprehensive way to explore all possible antenna layouts, its computational complexity makes it impractical for large-scale designs. As the number of Tx and Rx elements and space increases, the number of possible configurations grows exponentially, leading to long computation times and high resource consumption. This limitation drives the need for more efficient optimization techniques that can intelligently navigate the search space while still achieving near-optimal solutions.

To overcome these challenges, modern optimization techniques such as particle swarm optimization (PSO) and genetic algorithms (GA) are employed. These methods leverage heuristics, evolutionary principles, and mathematical modeling to explore the available space more efficiently, significantly reducing the time required to find an optimal antenna layout. For instance, genetic algorithms simulate natural selection by iteratively refining candidate layouts based on performance metrics defined using parameters discussed above. By shifting to these advanced optimization techniques, antenna designers can balance accuracy, computational efficiency, and design feasibility. Ultimately, optimization techniques allow for faster, more scalable, and cost-effective solutions while maintaining high detection accuracy, ensuring the radar system meets the demanding requirements of occupant monitoring applications.

Particle Swarm Optimization (PSO) is a powerful algorithm inspired by the collective movement of birds or fish in search of food. It is widely used in engineering applications, including antenna array design, due to its ability to efficiently explore complex search spaces while avoiding the computational burden of brute-force methods. In the context of in-cabin radar antenna layout optimization, PSO offers a highly effective approach for determining the optimal placement of transmit (Tx) and receive (Rx) elements to enhance angular resolution, reduce sidelobe levels, and maximize coverage within the given spatial constraints. In PSO, a set of potential solutions, called particles, move through the design space, each representing a unique antenna array configuration. These particles adjust their positions iteratively based on two factors. Personal best position, where the best layout is found by the individual particle so far. And Global best position where the best layout is found by any particle in the swarm.

Each particle updates its position using a velocity equation that balances exploration (searching for new potential solutions) and exploitation (refining promising solutions). Over successive iterations, the particles converge toward an optimal layout that meets performance criteria such as sidelobe suppression, beamforming accuracy, and detection reliability.

Genetic Algorithm (GA) is an evolutionary optimization technique inspired by the principles of natural selection and genetics. It may be used in antenna design to efficiently explore complex solution spaces and identify optimal configurations while minimizing computational effort. In the context of in-cabin radar antenna array design, GA helps determine the best placement of transmit (Tx) and receive (Rx) elements to enhance angular resolution, suppress sidelobes, and maximize field of view (FoV) under given spatial constraints. GA operates by treating each potential antenna configuration as an individual chromosome in a population. These chromosomes undergo an iterative process of selection, crossover, and mutation to evolve toward an optimal solution.

Initialization: A population of random antenna layouts is generated, each represented as a binary or numerical sequence encoding element positions. Fitness Evaluation: Each layout is evaluated based on performance metrics defined using parameters listed above. Selection: The best-performing layouts (individuals) are selected for reproduction, mimicking the principle of survival of the fittest. Crossover: Selected layouts exchange portions of their configurations, combining features from two parents to create new candidate solutions. Mutation: Small random changes are introduced in some offspring to maintain diversity and prevent premature convergence to suboptimal solutions. Iteration: The process repeats over multiple generations, gradually improving the antenna array layout until convergence criteria (e.g., minimal sidelobe levels, optimal angular resolution and coverage) are met.

As antenna array design for radar-based in-cabin sensing systems becomes more complex, optimizing a single objective (e.g., minimizing sidelobe levels or maximizing angular resolution) is often insufficient. One possible approach to address this challenge is to merge all objectives into a single composite objective function. In-cabin radar antenna designs require balancing multiple competing objectives, such as minimizing sidelobe levels (SLL), optimizing major and minor beamwidth angles to enhance angular resolution, reducing coupling between Rx elements or Tx elements to improve signal integrity, and optimizing coverage parameters, such as reducing the number of target points with SLLs exceeding the desired threshold, minimizing instances where sidelobes fall within the Field of View but fail to meet SLL criteria, and limiting the number of target points with multiple sidelobes exceeding the SLL threshold.

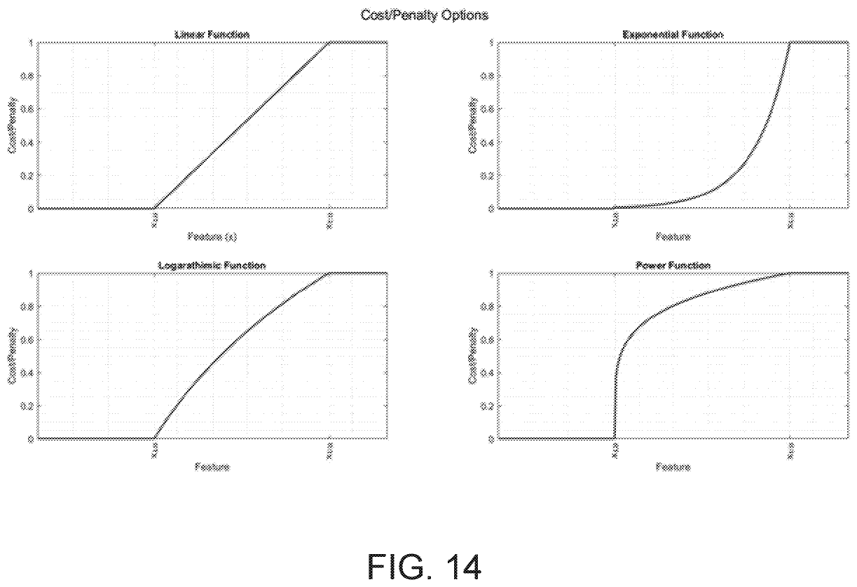

In optimization problems, cost/penalty functions play a crucial role in guiding algorithms like Genetic Algorithm (GA) and Particle Swarm Optimization (PSO) toward optimal solutions. The selection of a cost function type affects convergence speed, exploration-exploitation balance, and solution quality. By leveraging PSO, designers can efficiently explore a wide range of antenna configurations and achieve near-optimal performance without the excessive computational cost of brute-force approaches. FIG. 14 presents four different types of cost functions—Linear, Exponential, Logarithmic, and Power Functions—each affecting cost/penalty differently as the feature value increases.

The linear function shows a direct proportionality between the feature and the cost/penalty. As the feature value increases, the cost increases at a constant rate. This type of function is useful when the penalty needs to grow steadily with the feature value without abrupt changes.

The exponential function exhibits a slow increase in cost at lower feature values but grows rapidly as the feature approaches its upper limit. This behavior is suitable for cases where minor deviations in feature are tolerated, but larger deviations result in significantly higher penalties.

The logarithmic function begins at zero when the input feature is below the threshold and after this point, it increases in concave shape, rising quickly at first and then tapering off. The logarithmic behavior ensures that initial changes in the feature have slightly more impact, while later changes contribute relatively less to the total penalty.

The power function may have a steep increase in cost at lower feature values and gradually leveling off as the feature increases. The power behavior ensures that initial changes in the feature have more impact, while later changes contribute less to the total penalty.

The choice of cost/penalty function depends on the specific application and how the system should respond to variations in the feature. Linear functions are best for proportional penalties. Exponential functions emphasize significant penalties for large deviations. Logarithmic functions slightly prioritize feature variations around the lower limit. Power functions aggressively penalize deviations around the lower limit but may relax changes around the upper limit.

Synthetic ADC (Analog-to-Digital Converter) data generation for antenna layouts involves simulating the received radar signals based on a given antenna configuration and target parameters such as radar cross section (RCS), range, Doppler, azimuth, elevation, etc. This process is essential for testing and validating antenna arrays before deploying them in real-world radar-based applications like in-cabin sensing systems.

The radar emits periodic frequency chirps with a linearly increasing frequency, a technique known as Frequency-Modulated Continuous Wave (FMCW). Mathematically, it is represented as,

$${x}_{T} ( t ) = A cos ( 2 π {f}_{c} t + π \frac{B}{T} {t}^{2} + ϕ ( t ) )$$

where A is the transmitted power and φ(t) is the phase noise from the transmitter. The chirp parameters include the chirp starting frequency (f_{c}), the bandwidth of the chirp (B), the chirp duration (T_{c}), the fast-time-axis ADC sampling interval (T_{f}), and the slow-time-axis sampling interval (Tₛ).

The radar receives a time-delayed and attenuated version of the transmitted signal, expressed by,

$${x}_{R} ( t ) = {A}^{′} \{ cos ( 2 π {f}_{c} ( t - {t}_{d} ) + π \frac{B}{{T}_{c}} {( t - {t}_{d} )}^{2} + ϕ ( t - {t}_{d} ) ) \}$$

where A′ is the received power and,

$${t}_{d} = \frac{2 R ( t )}{c}$$

represents the range-dependent time delay for an object located at a radial distance R(t). The received signal is then mixed with a replica of the transmitted signal, and after I/Q mixing, it can be approximated as,

$$y ( t ) = {A}^{′} {e}^{j ( 2 π \frac{B}{{T}_{c}} {t}_{d} t + 2 π {f}_{c} {t}_{d} + π \frac{B}{{T}_{c}} {t}_{d}^{2} + Δϕ ( t ) )}$$

The residual phase noise given by,

Δφ(t)=φ(t)−φ(t−t_{d})

can be ignored for short range radar applications due to the range-correlation effect. Furthermore, the term

$$π \frac{B}{{T}_{c}} {t}_{d}^{2}$$

is negligibly small in practical scenarios and can also be disregarded. The beat signal after I/Q sampling can be expressed for the n^{th} ADC sample and the m^{th} chirp as,

$$y [ n , m ] = {A}^{′} {e}^{j ( 2 π {f}_{b} {nT}_{f} + \frac{4 π}{λ} R ( {nT}_{f} + {mT}_{s} ) )}$$

In a multi-receiver system, variations in the relative distances between receiver elements introduce an additional phase shift. When multiple targets exist within the radar's field of view, the received signal becomes a summation of contributions from all P targets located at (R_{P}, θ_{P}). It is given as,

$${y}^{′} [ n , m , i ] = {\sum }_{l = 1}^{P} {A}_{P}^{′} {e}^{j ( 2 π {f}_{b} {nT}_{f} + \frac{4 π}{λ} {R}_{P} ( {nT}_{f} + {mT}_{s} ) + \frac{2 π}{λ} {d}_{i} sin {θ}_{t} )}$$

where dᵢ is the relative distance of the i^{th} receiver and

$$\frac{2 π}{λ} {d}_{i} sin {θ}_{P}$$

is the phase shift at the i^{th} receiver and i^{th} target. The displacement of the body surface caused by vital signs has small amplitudes (<10 mm) and low frequencies (<4 Hz). As a result, phase variations during the chirp duration (fast-time axis) are negligible, making it sufficient to measure phase changes between consecutive chirps along the slow-time axis.

R_{P}(nT_{f}+mTₛ)≈R_{P,0}+R_{P}(mTₛ)

and the summation of contributions from all targets P becomes

$${y}^{′} [ n , m , i ] = {\sum }_{P = 1}^{P} {A}_{P}^{′} {e}^{j ( 2 π {f}_{b} {nT}_{f} + \frac{4 π}{λ} ( {R}_{P , 0} + {R}_{P} ( {mT}_{s} ) ) + \frac{2 π}{λ} {d}_{i} sin {θ}_{P} )}$$

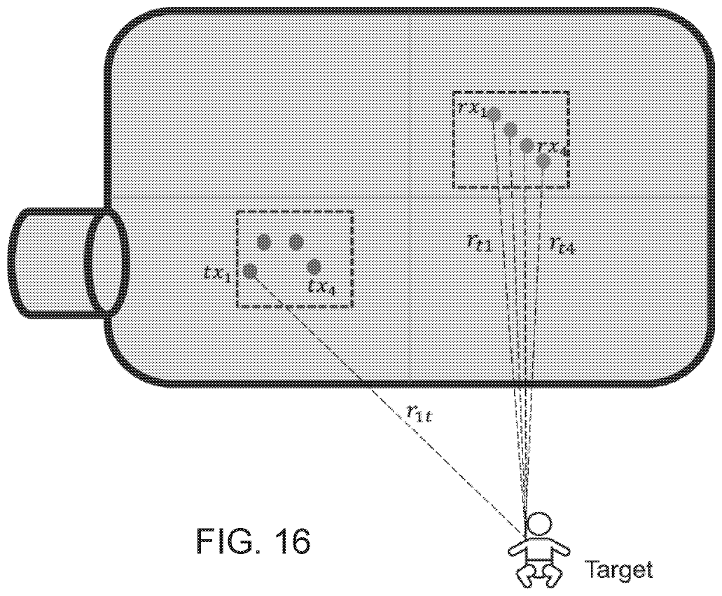

FIG. 15 shows range variation due to a determined vital sign of the occupant (e.g., breathing) and FIG. 16 shows example range information. The relative range information shown in FIG. 16 is utilized for ADC simulation. For any Tₓ-Rₓ pair, the total distance traveled by the mmWave signal is the sum of the distance from the transmitter to the target and the distance from the target to the receiver. Specifically, for Tₓ₁-Rₓ₁, this is given by,

r₁₁=r₁ₜ+rₜ₁

The same principle applies to all other Tₓ-Rₓ pairs, where the total signal travel distance follows,

rᵢⱼ=rᵢₜ+rₜⱼ

for any transmitter Tₓᵢ and receiver Rₓⱼ.

The system is designed to determine the optimal antenna geometry for in-cabin radar sensing, specifically for Child Presence Detection (CPD) and Multi-Occupant Detection (MOD). The objective is to identify two distinct antenna geometries that best address the requirements of each application.

For Child Presence Detection (CPD), the system focuses on selecting an antenna geometry that minimizes sidelobe levels while ensuring reliable detection of a child left inside the vehicle cabin. The setup includes multiple antenna geometries tested to determine the one with the least sidelobe level, best possible major and minor beamwidths and coverage parameters. The evaluation is based on a FoV of ±70 degrees in both azimuth and elevation. The primary goal is to achieve the lowest possible sidelobe levels for all targets within the defined FoV. Major and minor beamwidths and coverage parameters can be adjusted as needed to achieve better sidelobe reduction.

For multi-occupant detection (MOD), the experiment aims to determine the best antenna geometry that minimizes major and minor beamwidth while maintaining an acceptable sidelobe threshold. The setup involves various antenna geometries evaluated to analyze their impact on beamwidth, sidelobe level and coverage characteristics. The evaluation is based on a FoV of ±70 degrees in both azimuth and elevation. The primary objective is to achieve the best possible major and minor beamwidth while keeping sidelobe levels and coverage parameters within an acceptable minimum threshold.

By conducting these experiments, the most suitable antenna geometries for CPD and MOD can be identified, ensuring optimal in-cabin radar sensing performance for the customer requirements while meeting the specified design constraints.

With the brute force approach for the CPD requirement, the constraints applied in the algorithm include that the maximum allowable area for the array element may be 1.5λ×1.5λ (7.2 mm×7.2 mm). The system is configured with four transmitters and four receivers. The available element positions follow a discrete grid with λ/2 spacing in both the y and z directions. Physical array elements must not overlap. Virtual element overlap is not permitted to maximize the number of available virtual elements, thereby enhancing the virtual aperture extension.

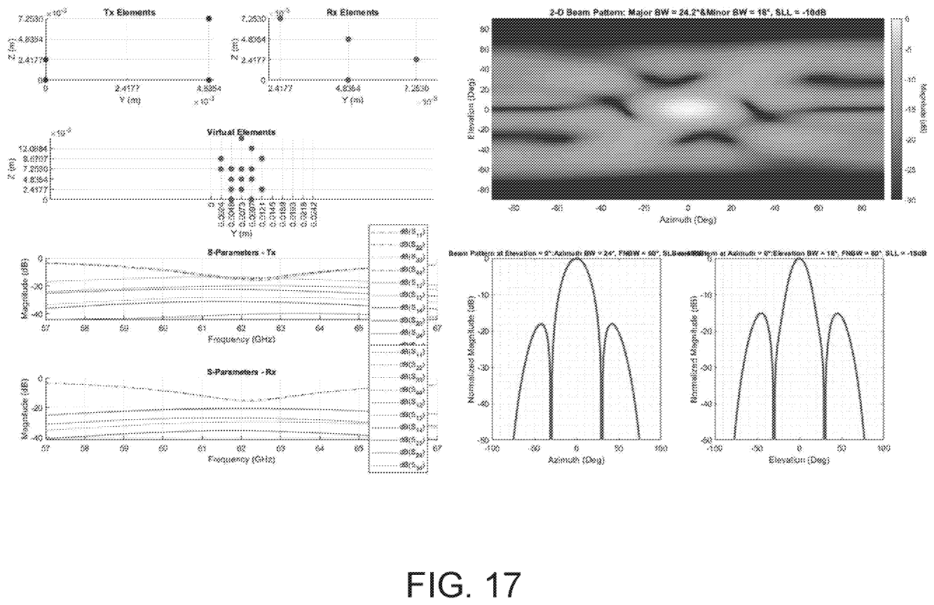

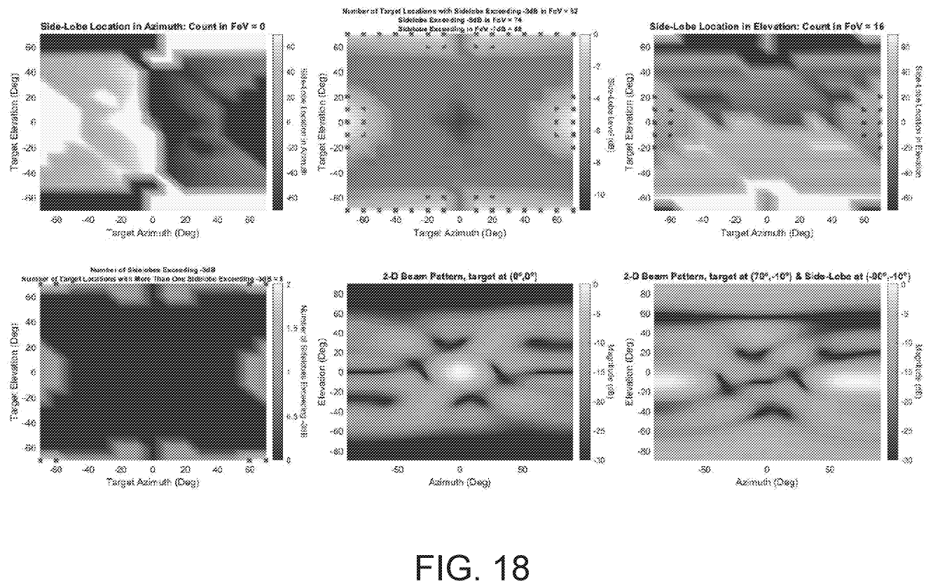

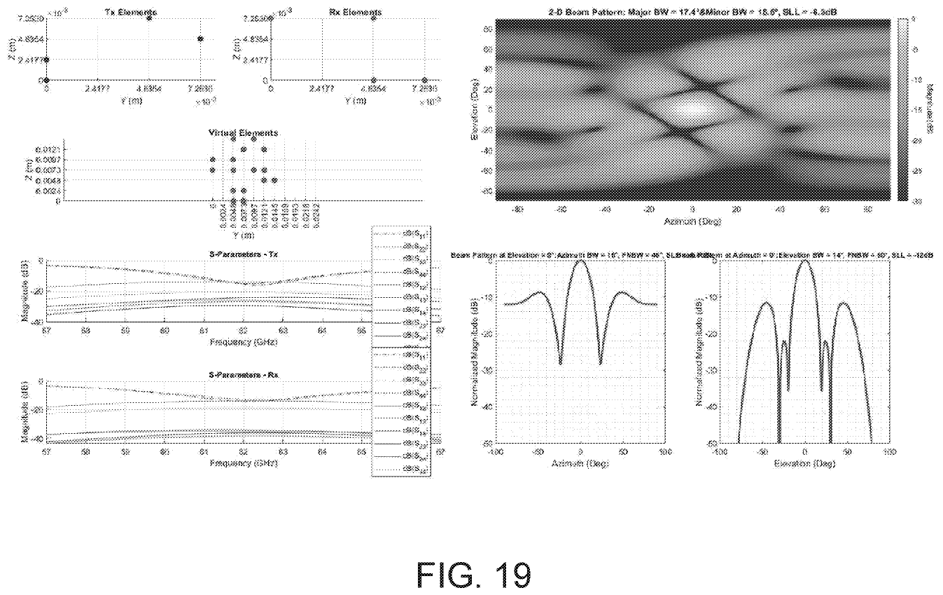

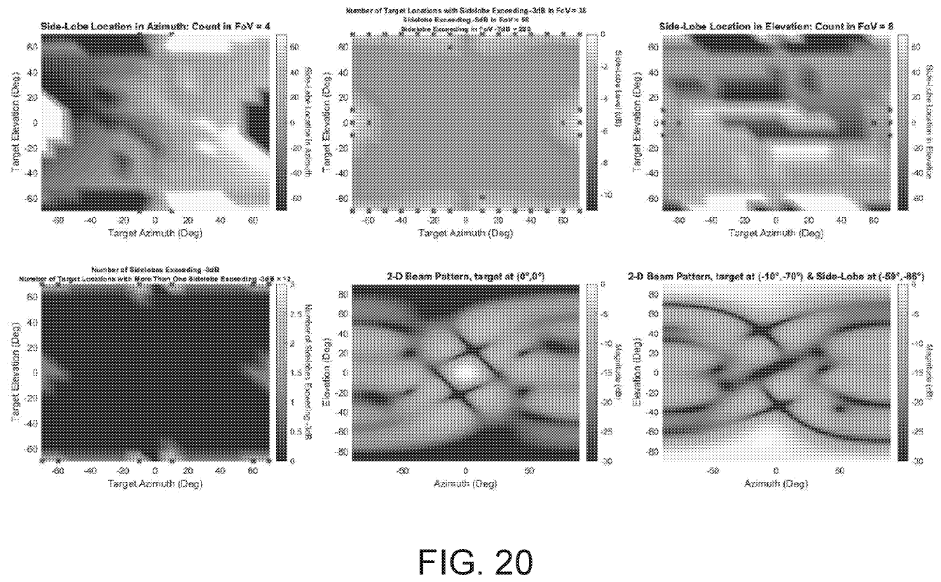

One of the optimal antenna geometries identified using the brute force approach for this evaluation for CPD is depicted in FIG. 17, with the corresponding coverage parameters presented in FIG. 18. Similarly for the MOD requirement, optimal antenna geometry is identified using the brute force approach and the same is illustrated in FIG. 19, with the corresponding coverage parameters shown in FIG. 20.

Since the Brute Force (BF) approach is computationally expensive, alternative optimization techniques are being explored to achieve similar results more efficiently. Methods such as genetic algorithms and particle swarm optimization can significantly reduce the search space while still identifying antenna geometries that meet the CPD and MOD requirements.

In addition to constraints described above, the major and minor beamwidth are evaluated using a linear cost function. SLL for a target at boresight is assessed using a linear cost function. Coverage parameters are incorporated using a linear cost function. All the defined costs are aggregated into a single objective function, which serves as the optimization criterion. The role of Particle Swarm Optimization (PSO) or Genetic Algorithm (GA) is to minimize this combined cost by intelligently exploring the search space and identifying the optimal antenna geometry.

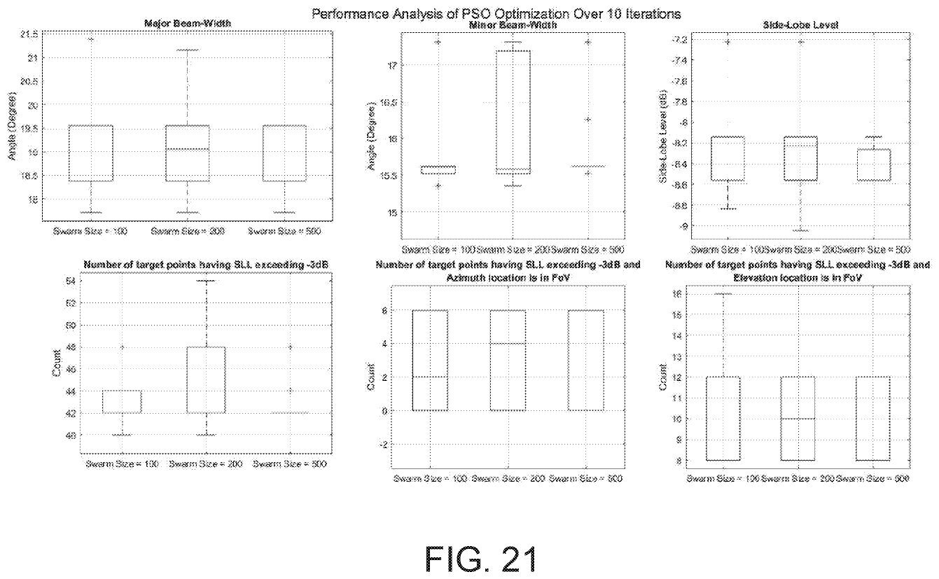

The evaluation of PSO performance over 10 independent iterations is summarized in FIG. 21, which illustrates variations in major and minor beamwidth, sidelobe levels, and the coverage parameters. The results indicate that increasing the swarm size does not significantly impact the optimization process.

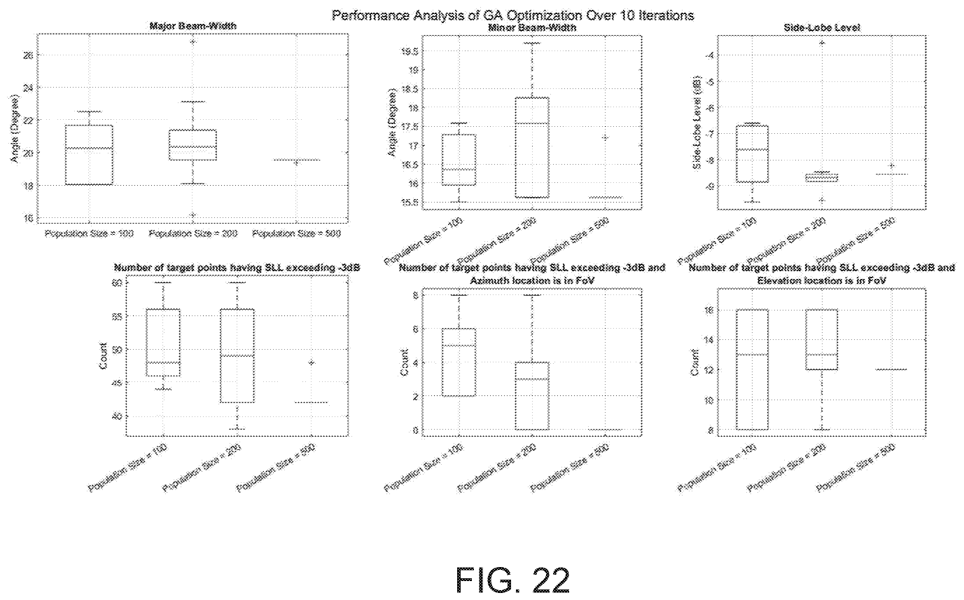

For the same cost, the evaluation of Genetic Algorithm (GA) performance over 10 independent iterations is summarized in FIG. 22, which illustrates variations in major and minor beamwidth, sidelobe levels, and the coverage parameters. The findings suggest that increasing the population size aids in the convergence of the optimization process.

The goal may be to compare the results obtained using the Brute Force (BF) approach with those derived from optimization techniques, such as Particle Swarm Optimization (PSO) or Genetic Algorithm (GA), for both CPD and MOD requirements. Genetic Algorithm (GA) is employed with the following parameters to optimize the antenna layout for multi-occupant detection. A population size of 200, maximum iterations of 100, maximum stall iterations of 50, and crossover fraction of 0.8. These parameters ensure a balance between exploration and convergence, allowing GA to efficiently search for an optimal antenna configuration while avoiding premature convergence.

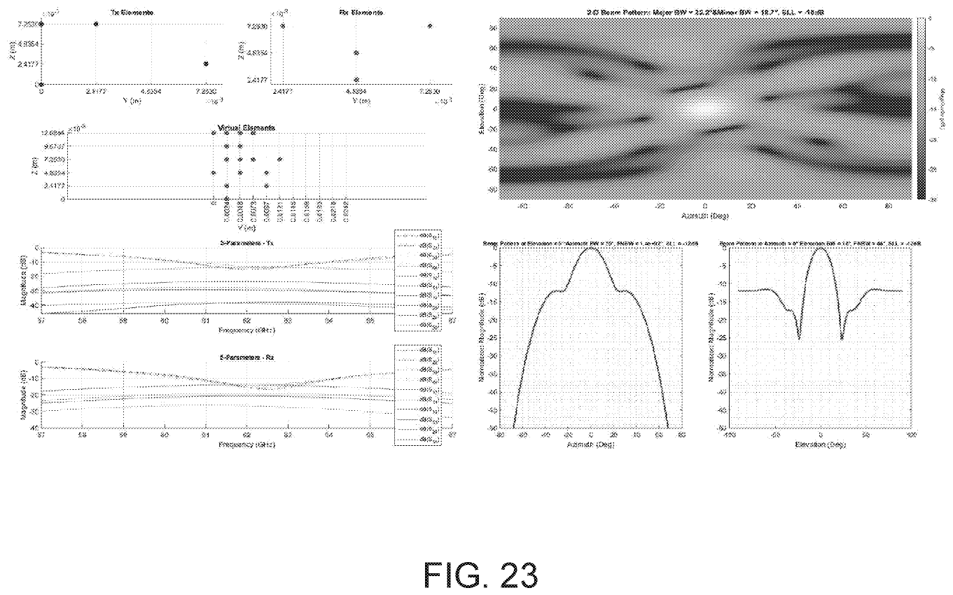

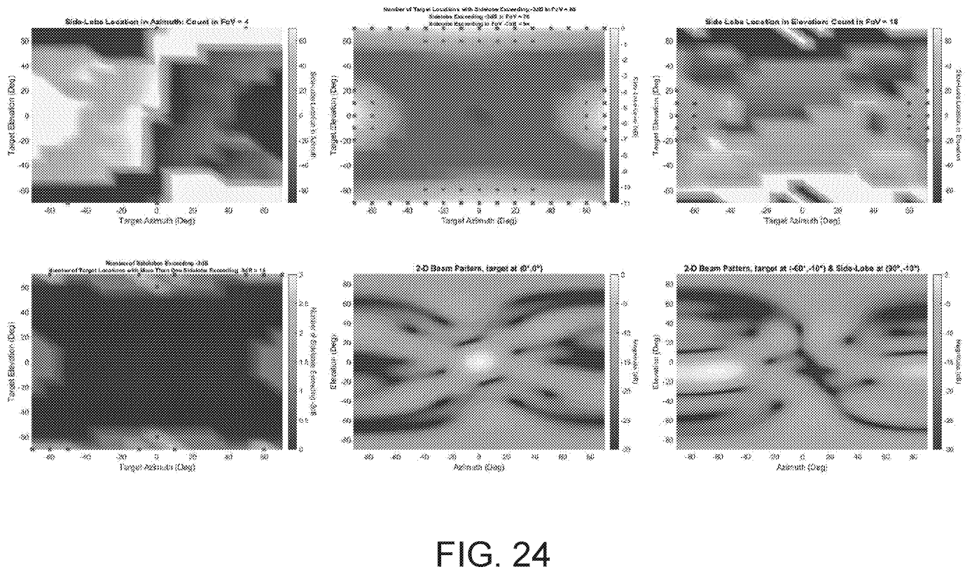

For the CPD requirement, the optimal antenna geometry is determined using GA optimization, as illustrated in FIG. 23, with the corresponding coverage parameters presented in FIG. 24. The performance of the antenna geometry obtained through GA optimization is compared with that derived from the Brute Force approach in the table of FIG. 25. It has been observed that the evaluation parameters obtained using both approaches are quite comparable.

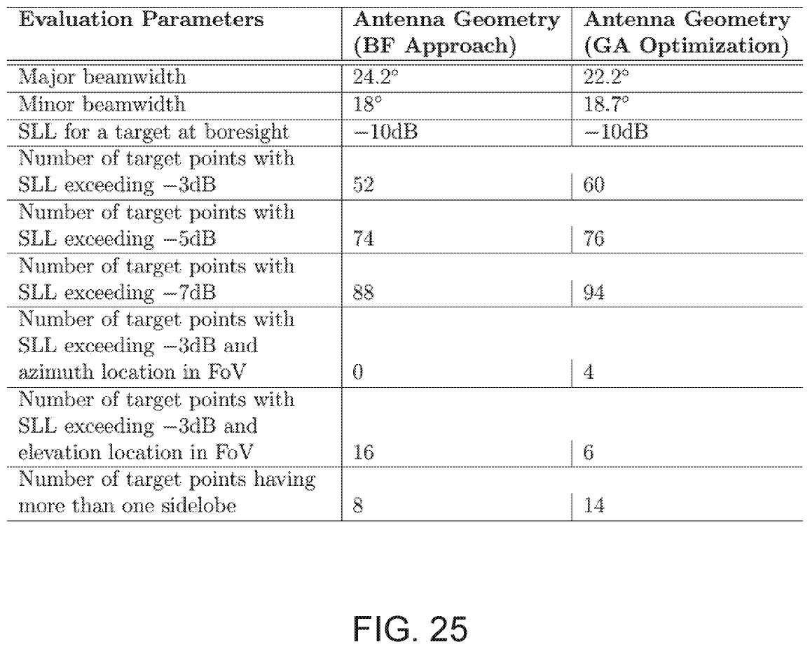

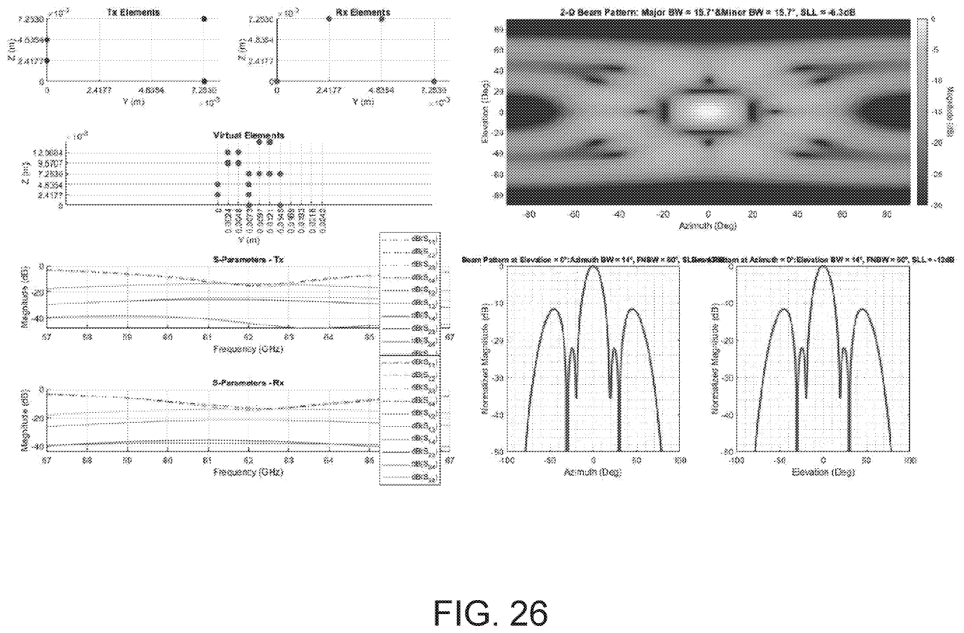

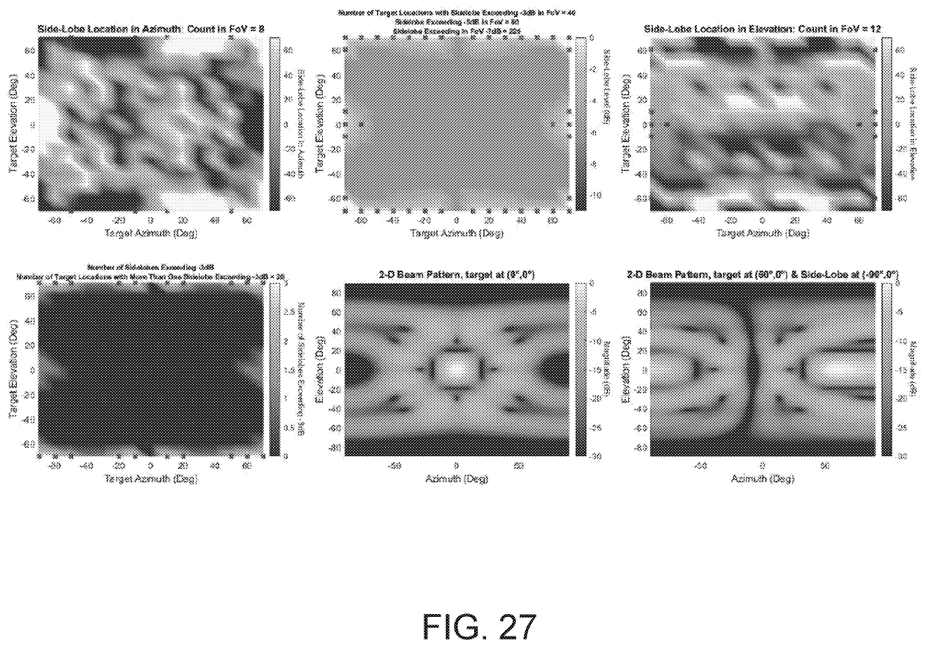

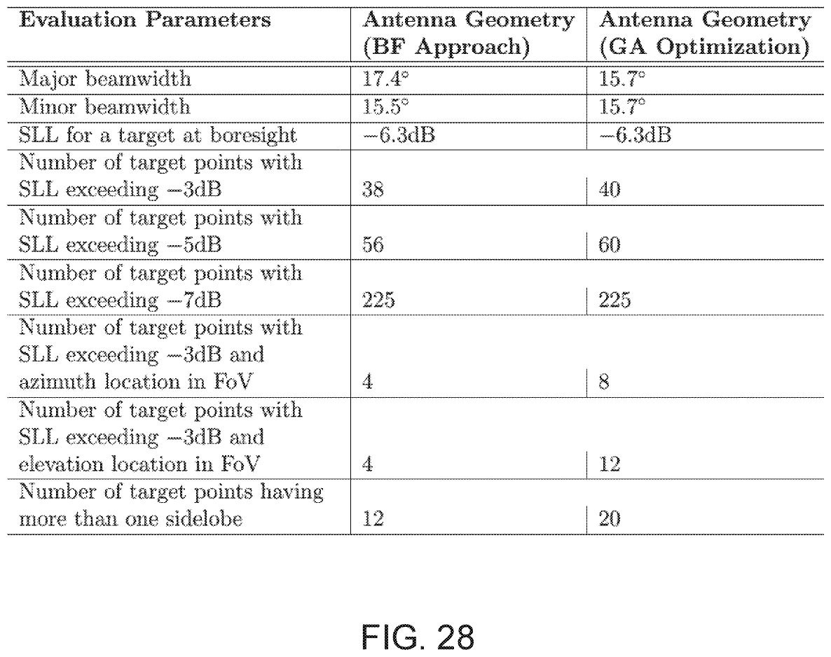

Similarly for the MOD requirement, optimal antenna geometry is identified using the GA optimization and the same is illustrated in FIG. 26, with the corresponding coverage parameters shown in FIG. 27. The performance analysis of the antenna geometry obtained through the GA optimization method is compared with the one derived from the Brute Force approach in the table of FIG. 28. It has been observed that the evaluation parameters obtained using both approaches are quite comparable.

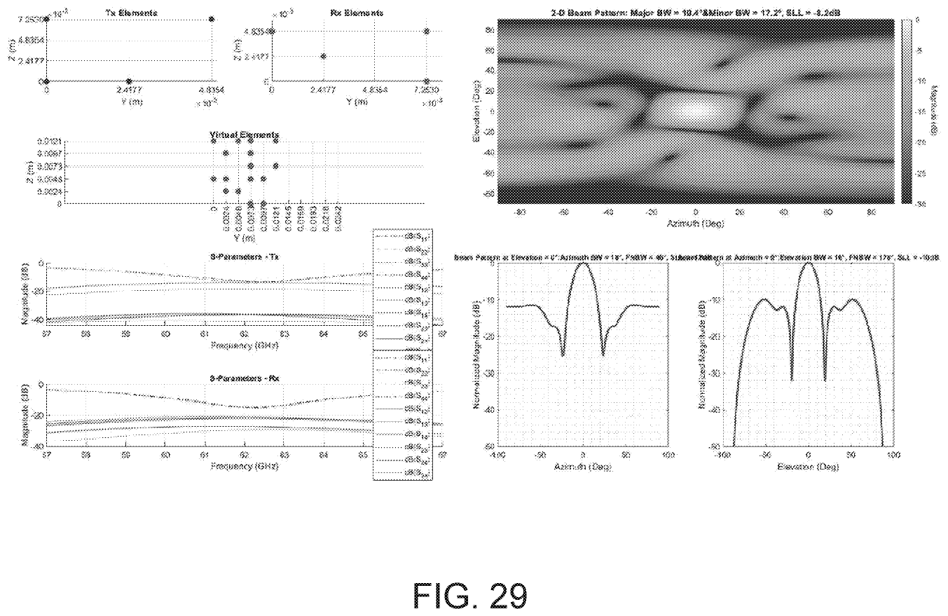

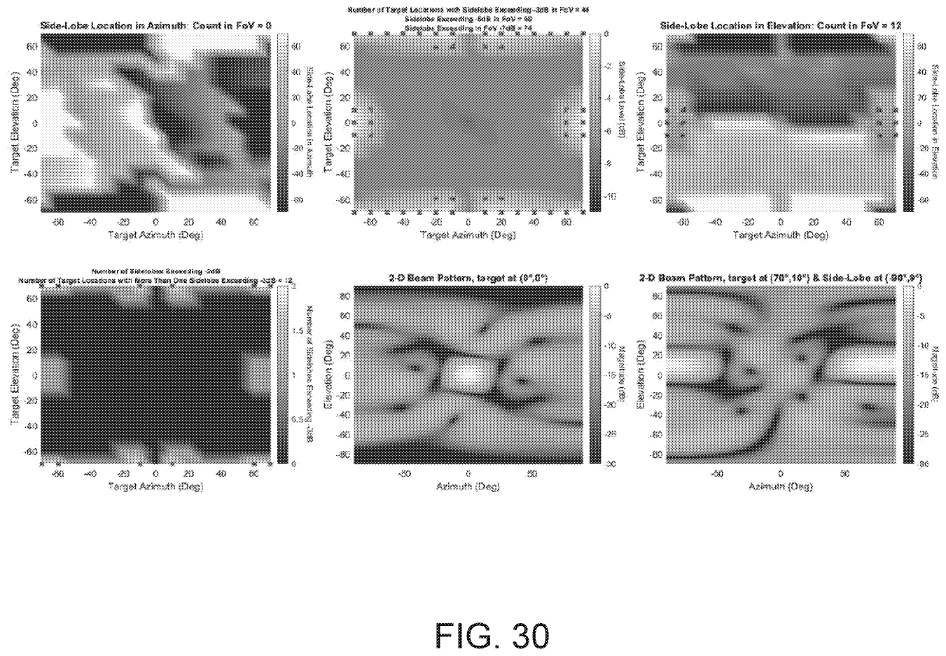

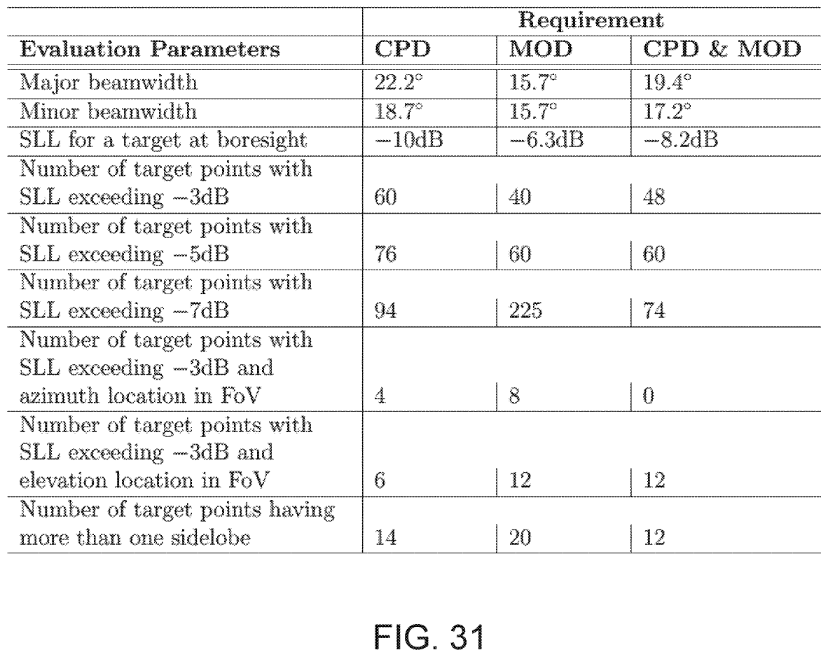

Since GA and PSO are not suitable for multi-objective optimization, the approach was shifted to Multi-Objective GA (MOGA). This method allows for simultaneous optimization of multiple conflicting objectives, such as maximizing resolution and coverage, while minimizing sidelobe levels. By leveraging the Pareto front approach, MOGA provides a set of optimal solutions, enabling a trade-off analysis between different performance metrics. One advantage of MOGA is that it provides multiple possible solutions, allowing for evaluation and selection based on specific requirements. In this study, MOGA was applied to derive a combined solution that addresses both Child Presence Detection and Multi-Occupant Detection requirements, enabling an optimal trade-off between the two. The optimal antenna geometry for these combined requirements is determined using MOGA and is illustrated in FIG. 29, with the corresponding coverage parameters presented in FIG. 30. The performance analysis of the antenna geometry obtained through the GA optimization method for different requirements is shown in the table of FIG. 31.

Constraints may be modified. For example, the maximum allowable area for the array element may be 3λ×3λ (e.g., 14 mm×14 mm). The available element positions may follow a discrete grid with 0.1λ spacing in both the y direction and the z direction. All other constraints may remain unchanged. This may be referred to as a “finer grid.” MOGA is once again utilized to optimize the antenna geometry while addressing multiple objectives, including CPD, MOD, or a combination of both. Furthermore, the antenna geometries are deliberately configured to offer finer angular resolution along one axis while permitting lower angular resolution along the other. This design choice aligns with typical in-vehicle mounting scenarios, where individual seats are distinguished along one axis and seat rows are identified along the perpendicular axis. While high angular resolution is not critical for distinguishing seat rows, it may aid in accurately detecting and localizing occupants within a given row.

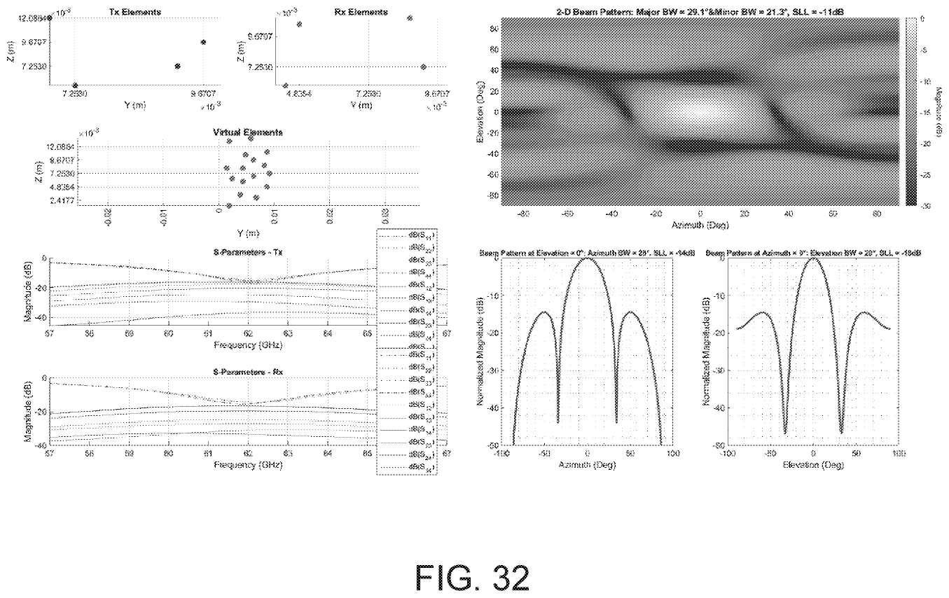

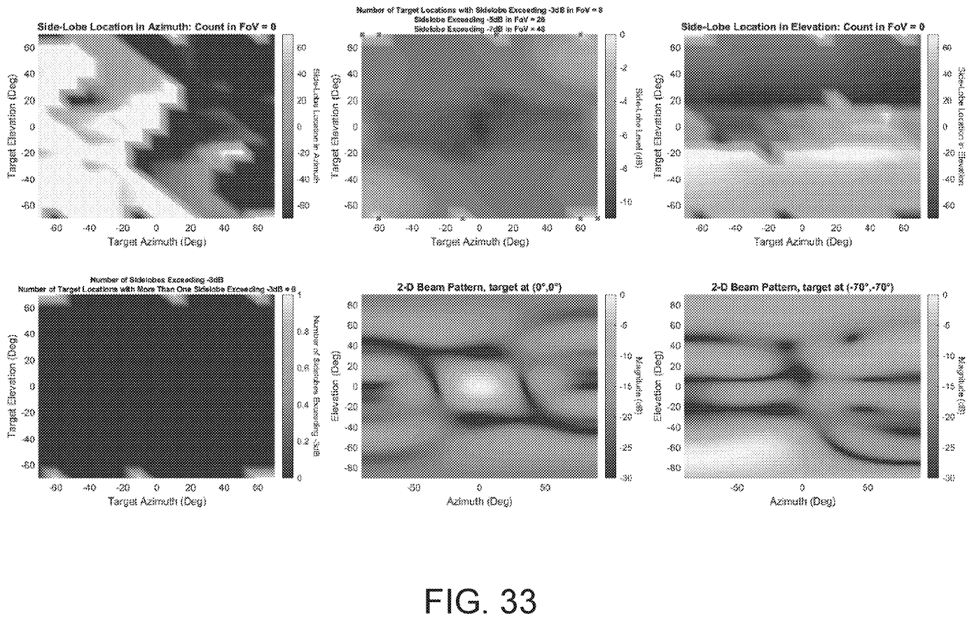

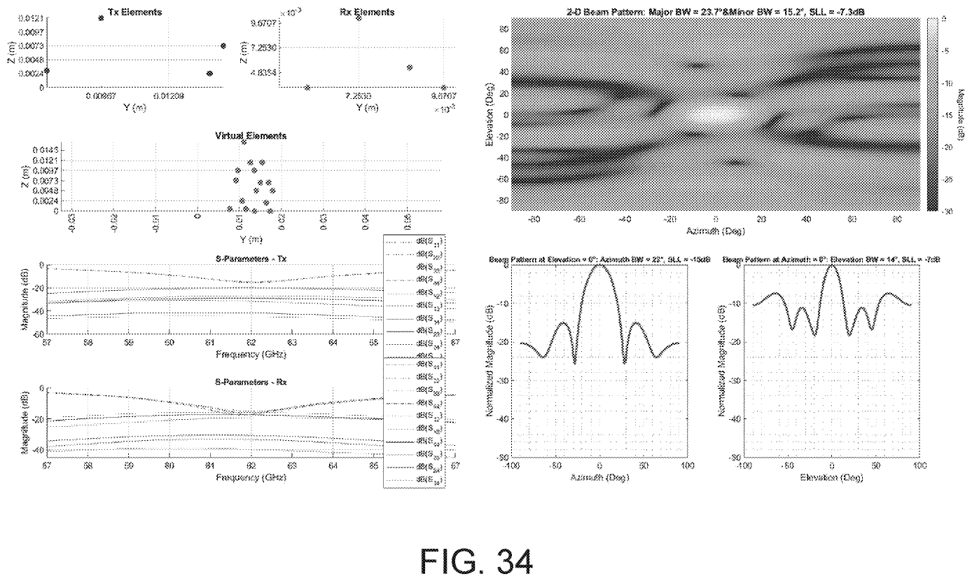

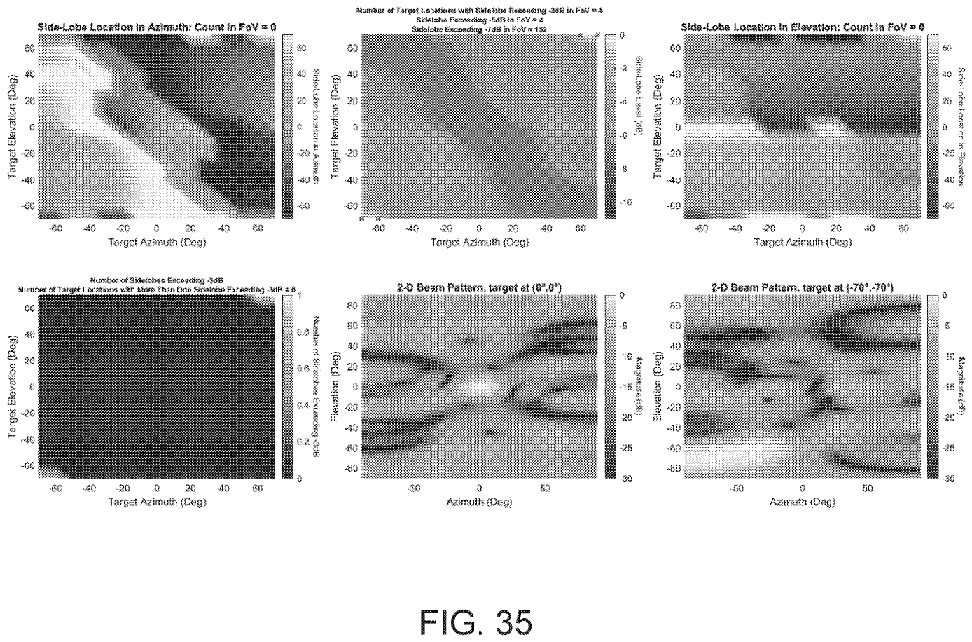

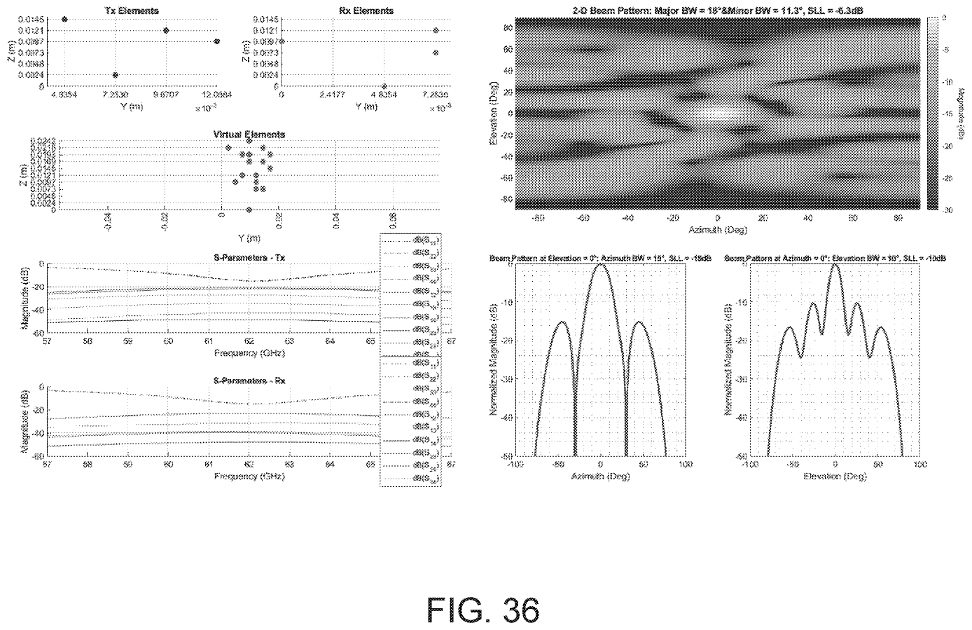

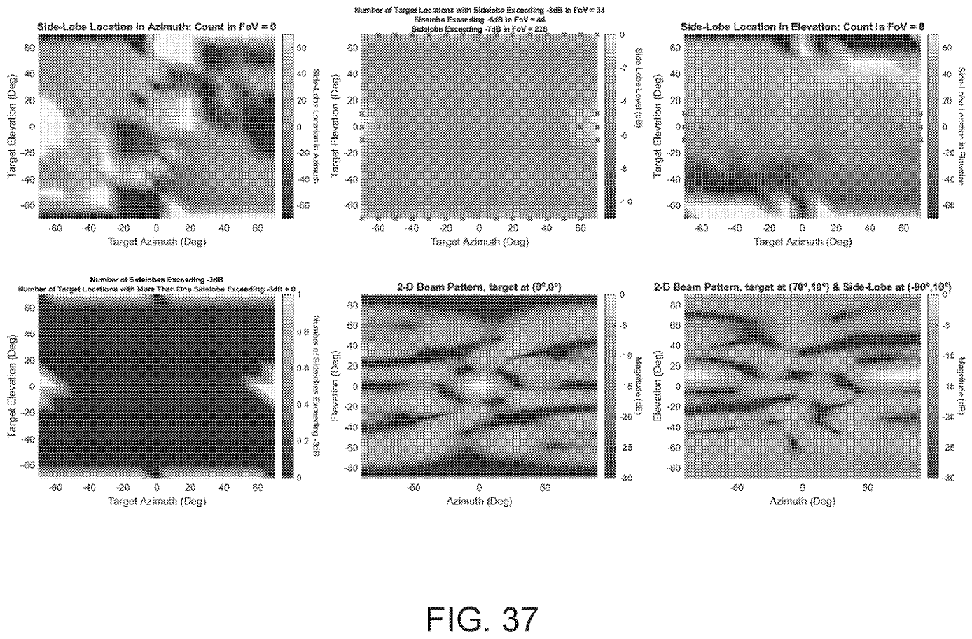

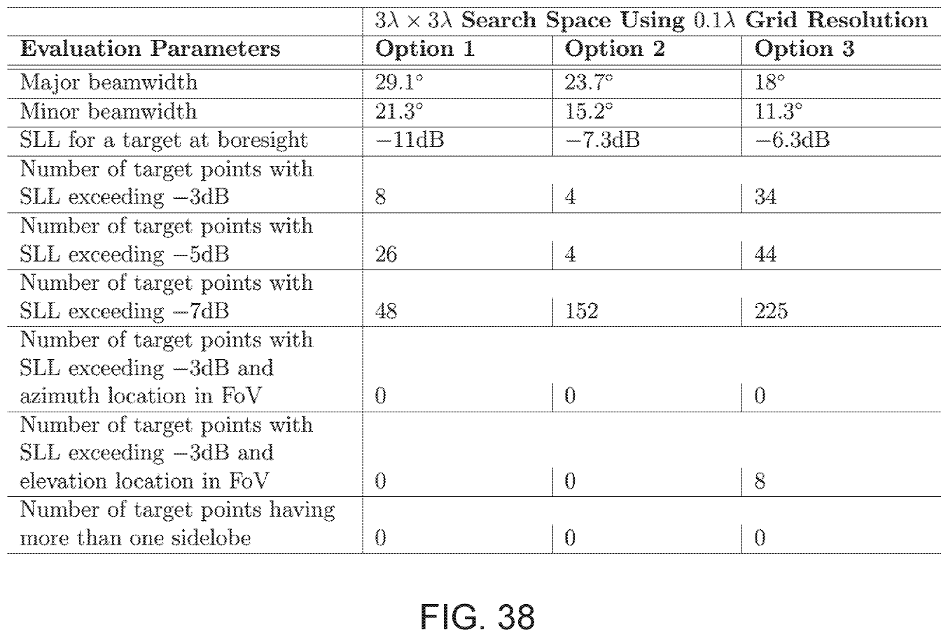

A first optimized configuration may be suitable for CPD applications. Its evaluation parameters are presented in FIG. 32, with corresponding coverage parameters shown in FIG. 33. A second optimized configuration provides a balanced design, supporting both CPD and MOD applications. Its evaluation parameters are shown in FIG. 34, while its coverage parameters are depicted in FIG. 35. A third optimized configuration may be suitable for MOD applications. The evaluation parameters for this configuration are shown in FIG. 36 and its coverage parameters are shown in FIG. 37. A comparative summary of all three configurations is provided in the table of FIG. 38.

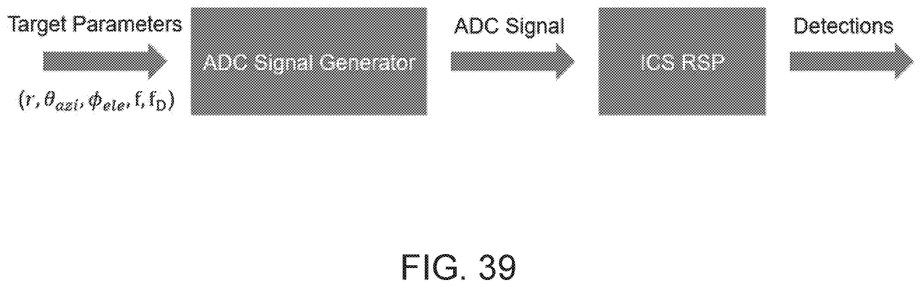

Synthetic target generation follows the block diagram of FIG. 39. The following parameters are used to generate the ADC signal. Target azimuth (θ_{azi}), target elevation (φₑₗₑ), target radar cross section (rcs), target breathing frequency (f), target breathing displacement (f_{D}).

A target is assumed to be present at a specific range with a defined breathing frequency and displacement. The target's azimuth and elevation angles vary from −70 to +70 in both directions, with a 10 degree grid. The corresponding ADC data is generated and fed into the ICS RSP software. The outputs are then extracted and compared against the known ground truth angle values. Sample antenna layouts obtained from the optimization process with finer grid are shown in FIGS. 32, 34 and 36, and are used for simulating the ADC data.

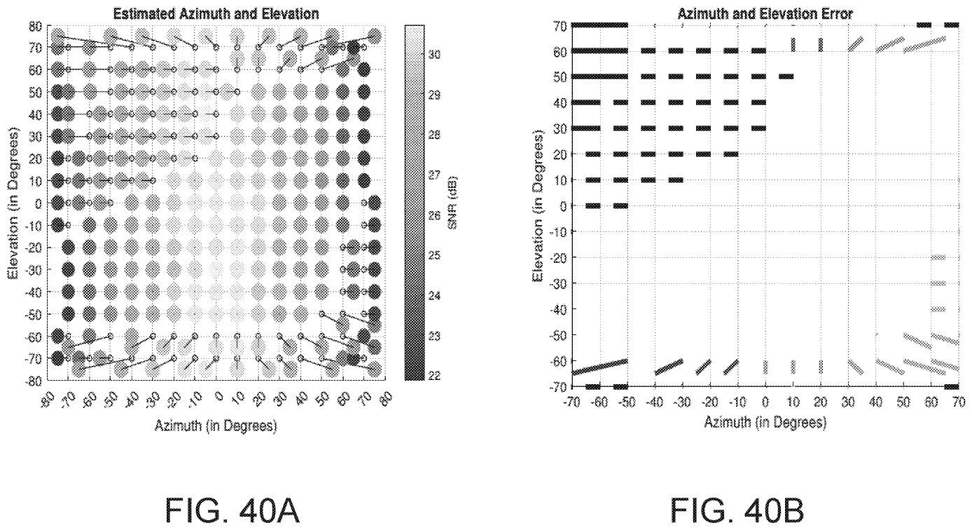

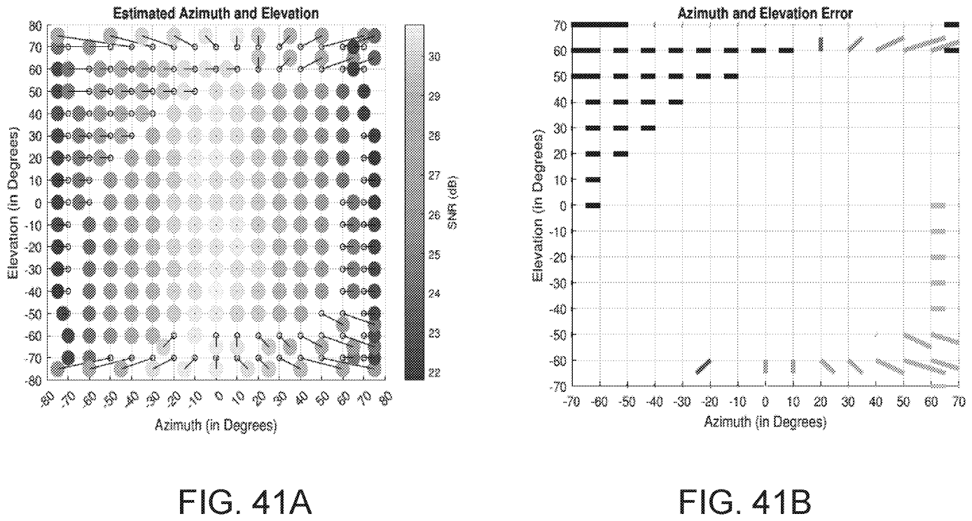

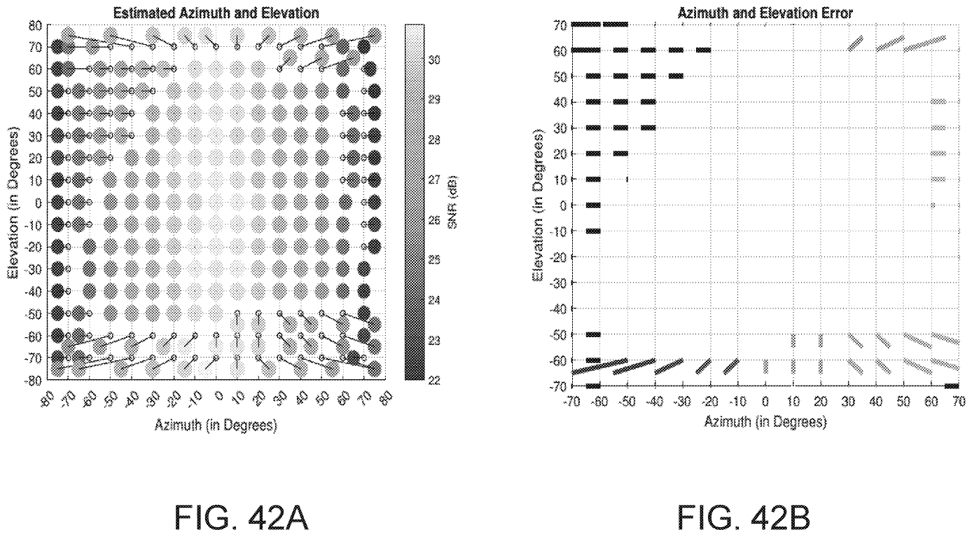

The estimated azimuth and elevation from the RSP software for the first example optimized antenna geometry of FIG. 32 are presented in the graph of FIG. 40A while the corresponding error is plotted in the graph of FIG. 40B. The estimated azimuth and elevation from the RSP software for the second example optimized antenna geometry of FIG. 34 are presented in the graph of FIG. 41A while the corresponding error is plotted in the graph of FIG. 41B. The estimated azimuth and elevation from the RSP software for the third example optimized antenna geometry of FIG. 36 are presented in the graph of FIG. 42A while the corresponding error is plotted in the graph of FIG. 42B. The results help validate the effectiveness of the optimized antenna layout by comparing the estimated parameters with the ground truth.

In-cabin sensing systems may detect, locate and classify occupants inside a vehicle. A fundamental aspect of designing a radar for this application is selecting the appropriate antenna layout. This system identifies the optimal layout for in-cabin applications by determining the right evaluation parameters and employing optimization techniques. That is, the performance of an in-cabin sensing system relies heavily on the antenna layout. The right geometry ensures accurate detection and classification of occupants. Major and minor beamwidth and sidelobe levels (SLL) may be used for evaluation. To accurately determine the performance of selected antenna geometry, relevant parameters should be extracted and evaluated, such as major and minor beamwidth angles (which determine the spread of the main lobe of the antenna pattern), SLLs (which indicate the intensity of the sidelobes relative to the main lobe, for minimizing interference), coupling parameters (which quantify interaction between the antenna elements specifically), transmitting elements (Tₓ-Tₓ coupling), and receiving elements (Rₓ-Rₓ coupling). These aid in evaluating mutual interference in multi-element radar systems. Additionally, the system evaluates the number of target points with SLLs exceeding the desired threshold (which counts the instances where sidelobes exceed acceptable levels), the number of instances where sidelobes fall within the FoV while failing to meet SLL requirements (which identifies sidelobes that interfere within the FoV but do not meet the SLL requirements), and the number of target points with multiple sidelobes exceeding the SLL threshold (which assesses the presence of multiple interfering sidelobes).

Combining traditional and newly defined parameters provides a more clear understanding of the antenna geometry's performance across the entire field of sensing of the radar. This comprehensive evaluation allows for a more informed selection of the optimal antenna layout. Given the vast search space for antenna layouts, exhaustive searches are impractical due to limited resources. Therefore, optimization techniques are employed to find the best layout efficiently. This ensures accurate and reliable occupant detection and classification, enhancing the overall safety and functionality of the vehicle.

That is, to determine the optimal antenna geometry for the given requirements, the system explores evaluation parameters. Once these parameters were confirmed, they were used to derive the best antenna layout within a smaller placement area using the brute force approach. Various optimization techniques, including PSO, GA, and MOGA may improve efficiency. After validating that the optimization results closely matched those obtained through brute force, the approach was extended to a larger defined area. Among the optimization methods, MOGA was found to be the most effective, providing a balanced trade-off between multiple conflicting objectives. The optimized layout may be tested by feeding synthetically generated ADC data into the ICS system, ensuring its effectiveness in practical scenarios.

FIG. 43 shows an example arrangement of operations for a method 4300 of determining an optimized antenna layout for the radar sensor 16 of the cabin monitoring system 12. At operation 4302, the method 4300 includes receiving input constraints. This includes the number of transmitter and receiver elements, field of view or field of sensing in azimuth and elevation, maximum available space for transmitter and receiver in hardware, operating frequency/wavelength, and the like. At operation 4304, the method 4300 includes defining objective functions. This considers at least one of the following factors. It may assume at least one antenna model (e.g., isotropic, patch, and the like). It may assume far-field or near-field models, radar configurations like MIMO, TDM, FMCW, associated waveforms, and the like. It may be on grid or off grid and may have constraints on min and/or max distance between two elements. It may consider the Tₓ-Tₓ, Rₓ-Rₓ, and Tₓ-Rₓ coupling parameters. It may consider parameters from beam pattern at boresight: major, minor beamwidths, SLL, skewness of main lobe, and the like. It may consider parameters related to coverage. This forms a key aspect of the system and provides better antenna placement outcomes, as discussed further below. It may define appropriate functions that map the above parameters to cost (linear, exponential, and the like). The objective function may consider cost based on output of operation 4308 using vehicle models, and the like.

At operation 4306, the method 4300 includes optimization of antenna element positions. This may use any suitable method, such as PSO, GA, MOGA, and the like. Custom optimization methods may be considered and multiple methods may be used together.

At operation 4308, the method 4300 evaluates performance. This may consider synthetically generated radar signal models for in-cabin and/or external systems to evaluate the performance of the antenna layout. Further, it may generate necessary KPIs and may be used to redefine the cost function or could be a cost/objective by itself.

At operation 4310, the method 4300 outputs one or more proposed array layouts. This may consider a fusion of two or more layouts. Further, a static/adaptive controlled switching mechanism may select the antenna elements preferably without increasing the total number of channels.

Performance evaluation parameters of operation 4308 may be strongly related with defining the objective function of operation 4304. For example, smaller major and minor beamwidth provides better resolution. Therefore, the system may determine the major and minor beamwidth, map it to a cost value which the system will try to minimize. For example, the major beamwidth may need to be optimized between lower and upper bound values [15, 30] with a linear cost as shown in FIG. 14. A synthetic model may be used to evaluate the performance of the proposed antenna geometry in operation 4308. This output may be converted to a metric and made part of the objective function itself. At operation 4306, the method 4300 utilizes the objective function and minimizes the overall cost for different antenna element positions.

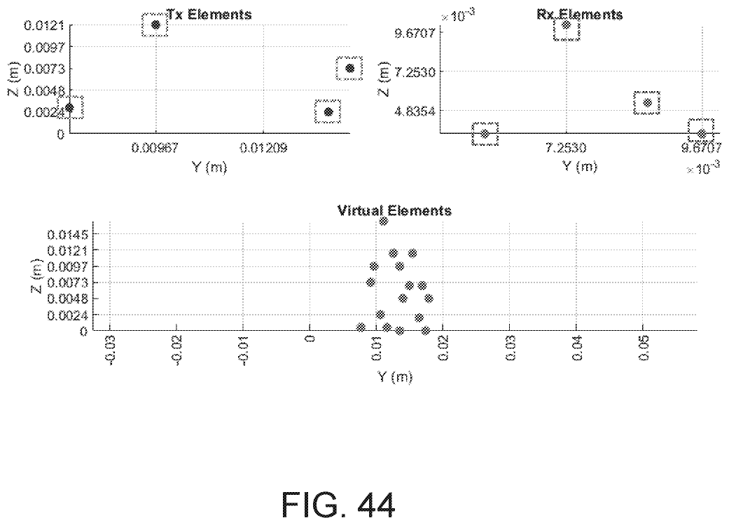

At operation 4308, the method 4300 utilizes evaluation parameters for the objective/cost function. That is, the geometry of the antenna is optimized by controlling/defining the objective/cost function which includes at least one basic parameter and/or the proposed coverage, jitter, and synthetic model-based parameters for single and/or multi-target scenarios. The basic parameters are those parameters which are commonly used to define the objective function. Examples include major and minor beamwidth with target at boresight, side lobe level with target at boresight, skewness of beam pattern, mutual coupling between Tₓ-Tₓ and/or Rₓ-Rₓ and/or Tₓ-Rₓ where Tₓ refers to transmitters and Rₓ refers to receiver. The proposed coverage parameters defining the objective function which considers single target at boresight and non-boresight angles comprises at least one of major beamwidth or its transform (average, min, max, and the like) at one or more non-boresight angle, minor beamwidth or its transform (average, min, max, and the like) at, at least one non-boresight angle, number of target points having SLL values higher than certain limit, number of target points with higher SLL values and SLL locations falling in the desired FoV, number of target points with more than one SLL peaks higher than certain limit, number of target points with more than one higher SLL values and SLL locations falling in the desired FoV. The proposed multi-target parameters defining the objective function which considers scenarios with more than one target at boresight and/or non-boresight angles comprises at least one of the parameters explained above (basic and/or coverage parameters). The objective function may also use proposed parameter which considers the effect of jitters in the antenna positions based on at least one jitter model using at least one metric defined above or their transformed versions. Example, take max or min or mean for metric SLL exceeding threshold across multiple jitter positions (FIG. 44). The objective function may also use proposed parameter which considers a metric such as accuracy or error in angle estimation from at least one available synthetic signal model for simulation of interior cabin system.

Referring to FIG. 44, jitter parameters may consider the effect of jitters in the antenna positions based on at least one jitter model using at least one metric defined above or their transformed versions. For example, take the max or min or mean for metric SLL exceeding threshold across multiple jitter positions. An example of jitter modelling may consider evaluation of performance parameters/objective function if the potential antenna element location varies about the desired location. This could be random position movement along at least one dimension (e.g., the y and/or z axis) within a small bounding region. This may be applied to at least one of the transmitters and/or at least one of the receivers.

Synthetic model parameters consider a metric such as accuracy or error in angle estimation from at least one available synthetic signal model for simulation of the interior cabin system.

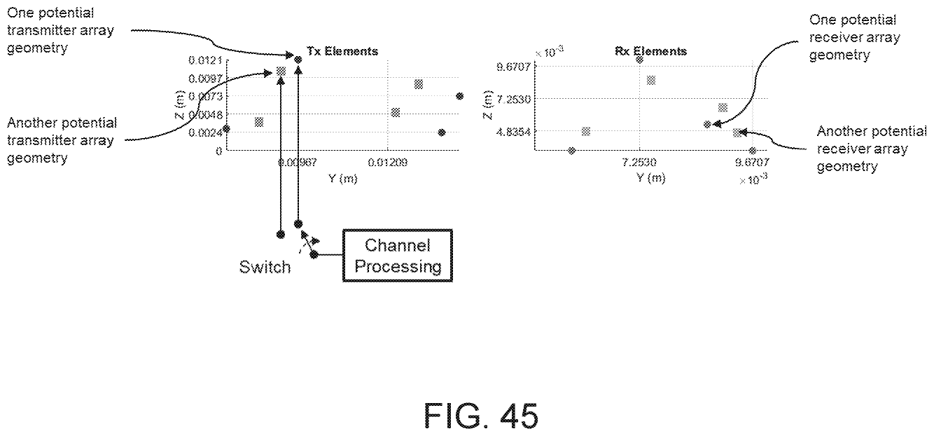

As shown in FIG. 45, a switching strategy may generate two or more potential or alternative transmitter array geometries and two or more potential or alternative receiver array geometries. The system may switch between these elements electronically or switch between the antenna element positions in hardware.

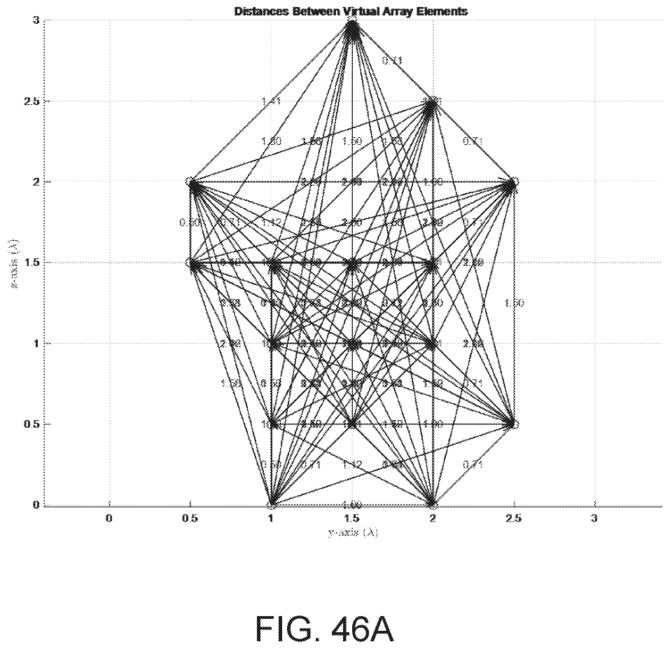

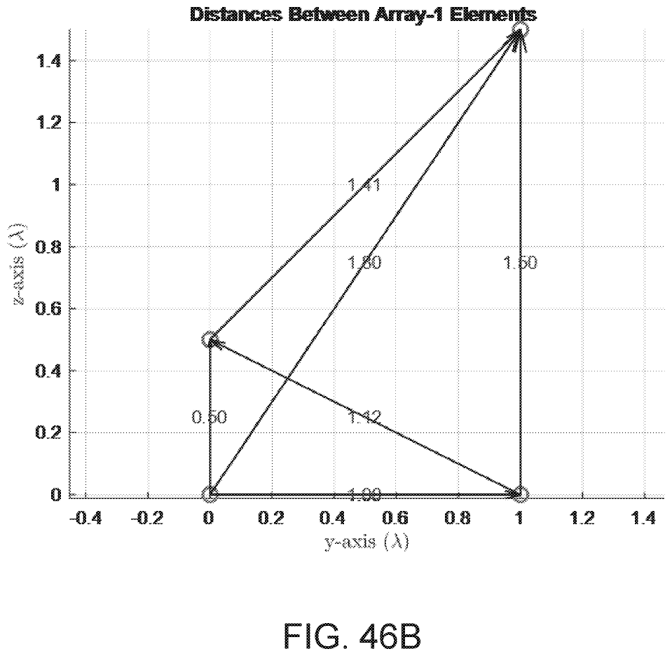

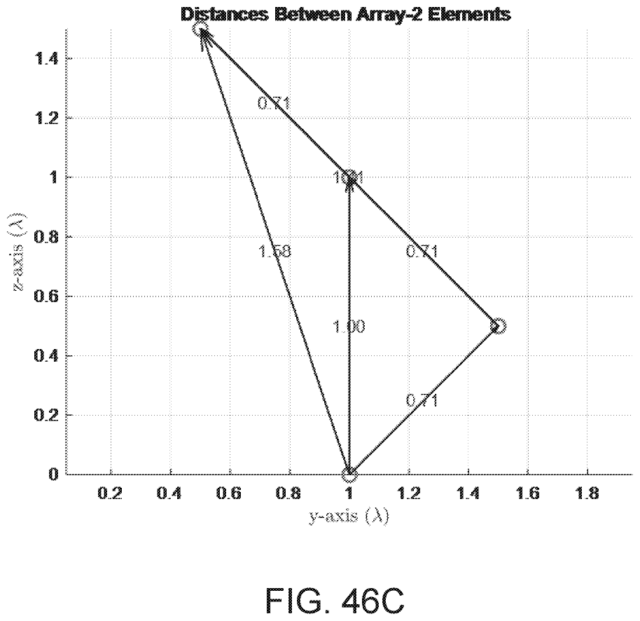

FIG. 46A shows a virtual array pattern in terms of distances between elements that are optimized or determined using a brute force method for CPD operation. FIGS. 46B and 46C respectively show a first array and a second array in terms of distances between elements that are optimized or determined using the brute force method for CPD operation.

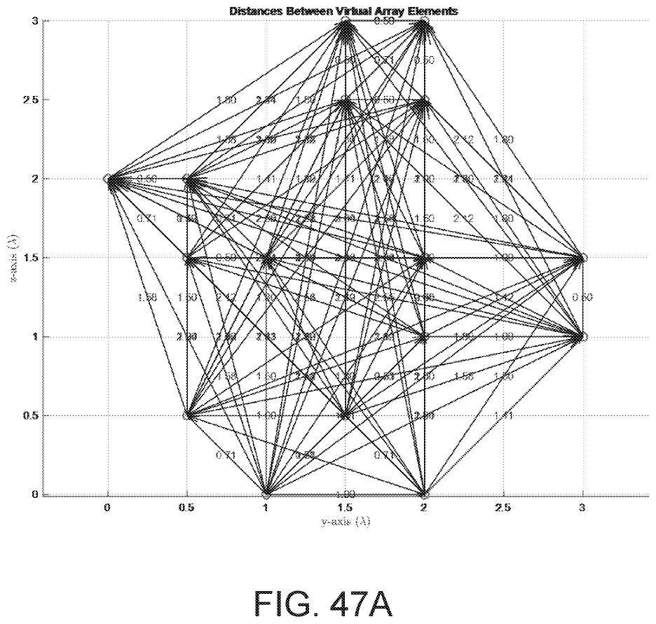

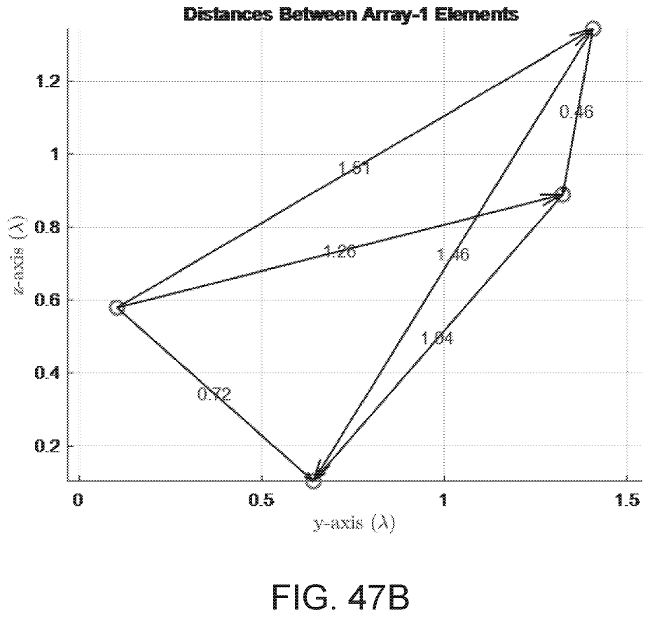

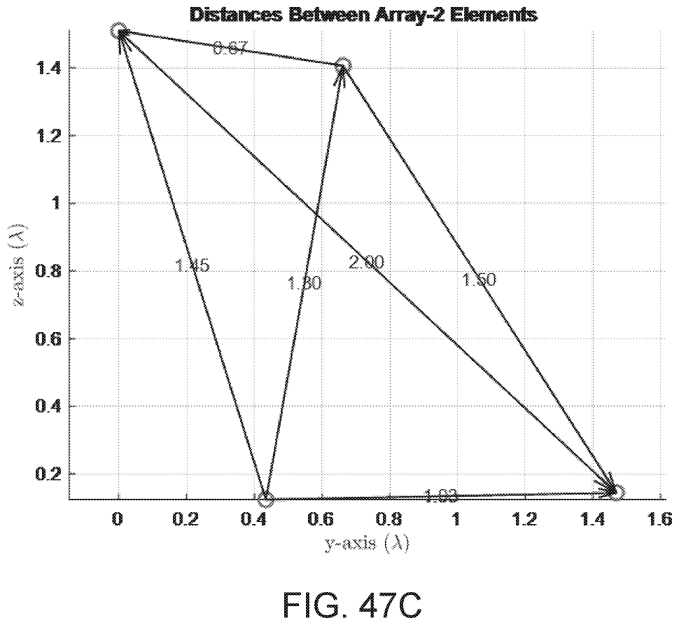

FIG. 47A shows a virtual array pattern in terms of distances between elements that are optimized or determined using a brute force method for MOD operation. FIGS. 47B and 47C respectively show a first array and a second array in terms of distances between elements that are optimized or determined using the brute force method for MOD operation.

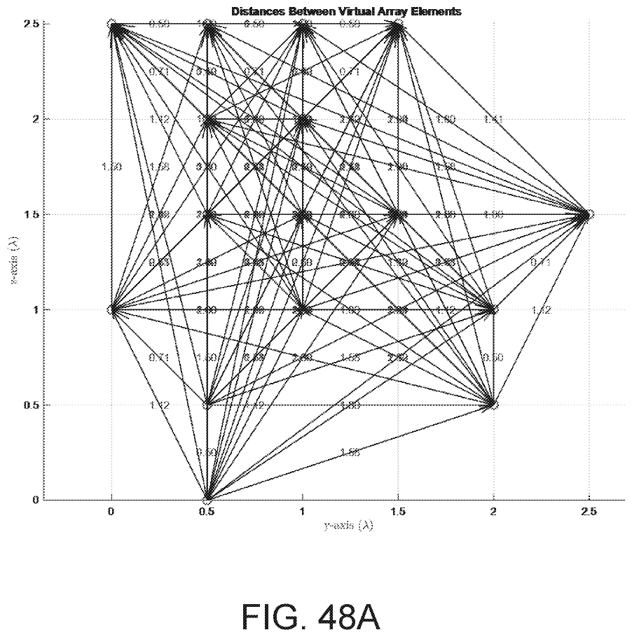

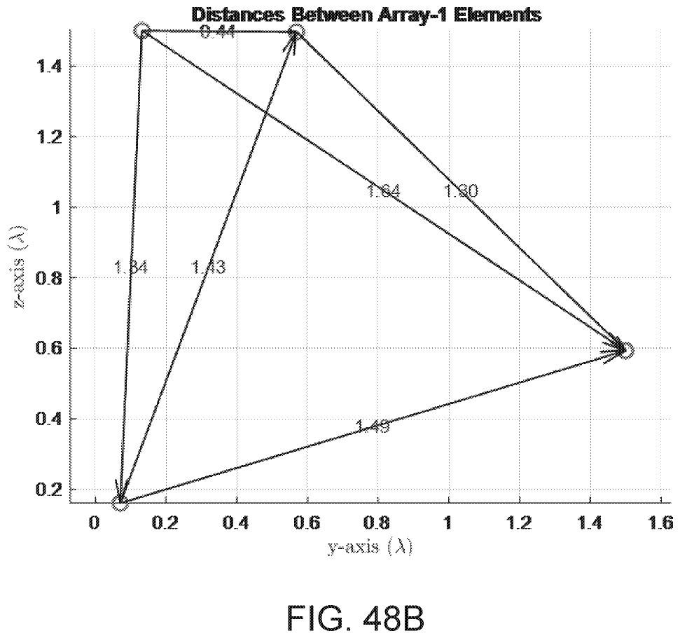

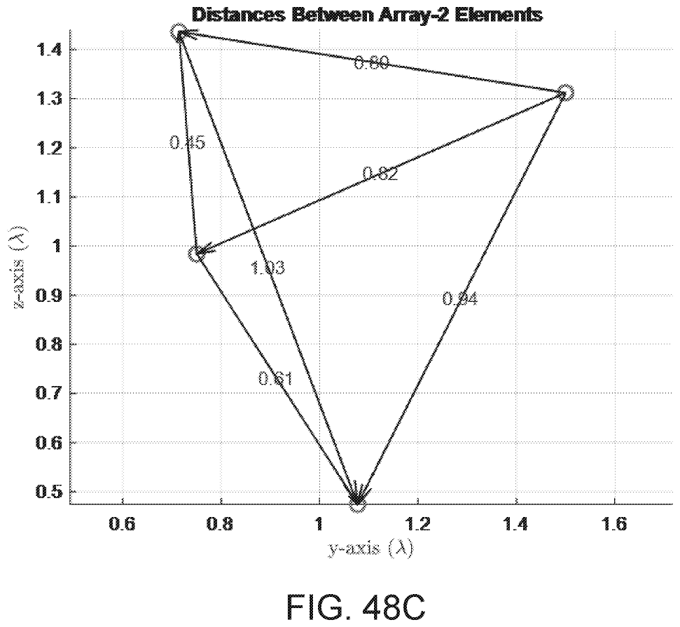

FIG. 48A shows a virtual array pattern in terms of distances between elements that are optimized or determined using a GA method for CPD operation. FIGS. 48B and 48C respectively show a first array and a second array in terms of distances between elements that are optimized or determined using the GA method for CPD operation.

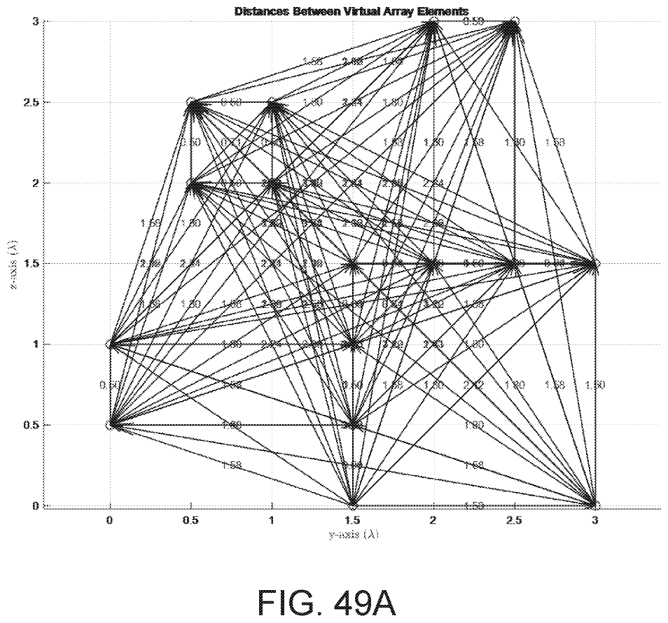

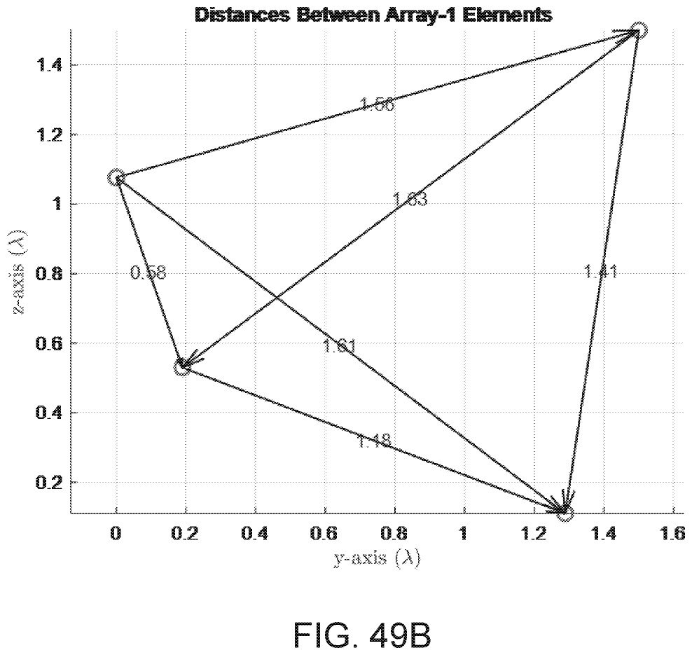

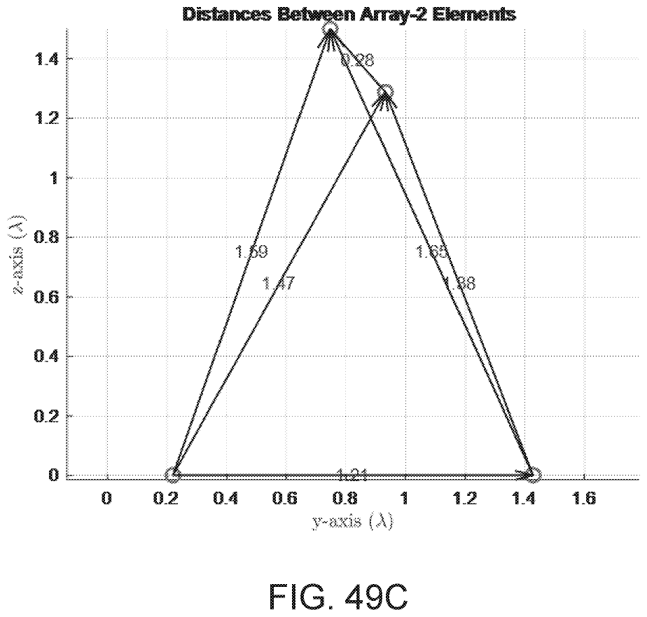

FIG. 49A shows a virtual array pattern in terms of distances between elements that are optimized or determined using a GA method for MOD operation. FIGS. 49B and 49C respectively show a first array and a second array in terms of distances between elements that are optimized or determined using the GA method for MOD operation.

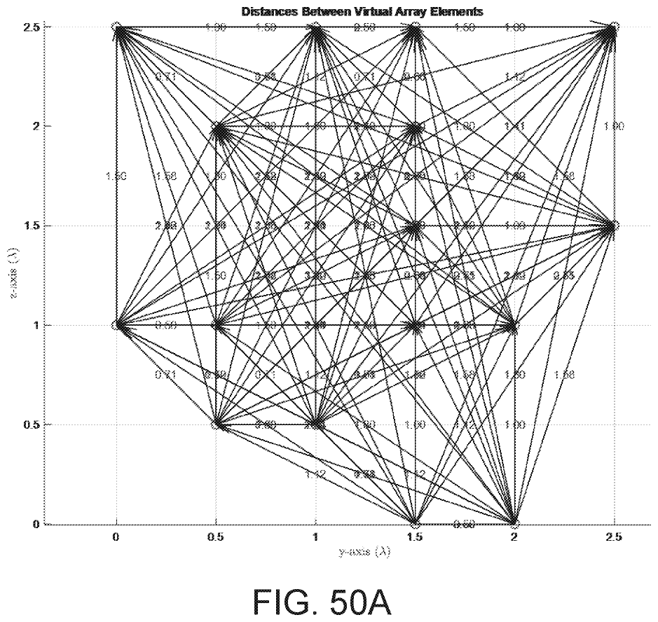

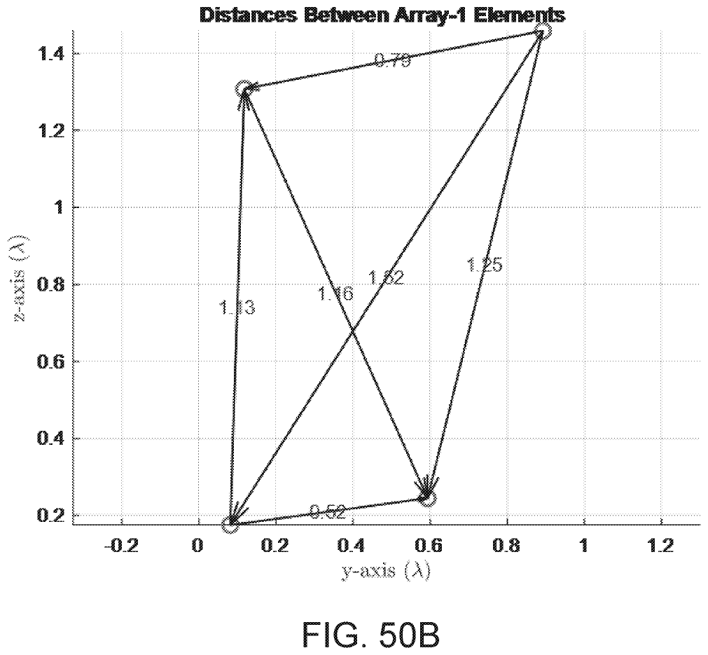

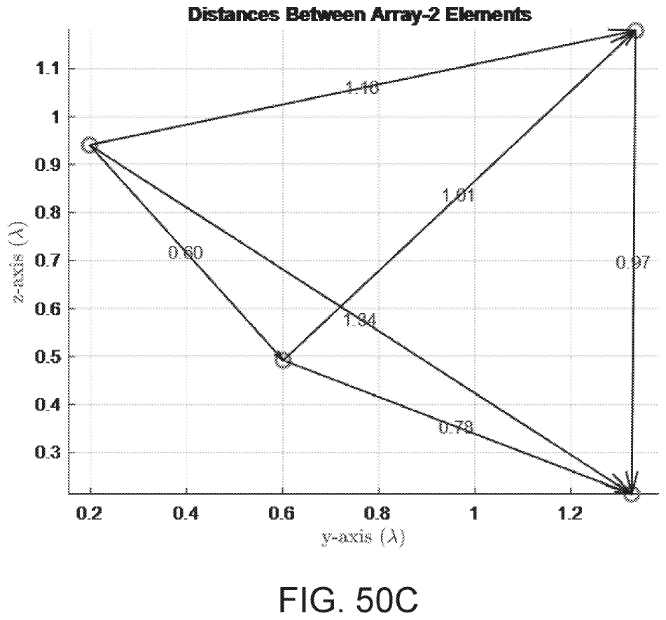

FIG. 50A shows a virtual array pattern in terms of distances between elements that are optimized or determined using a MOGA method for CPD-MOD operation. FIGS. 50B and 50C respectively show a first array and a second array in terms of distances between elements that are optimized or determined using the MOGA method for CPD-MOD operation.

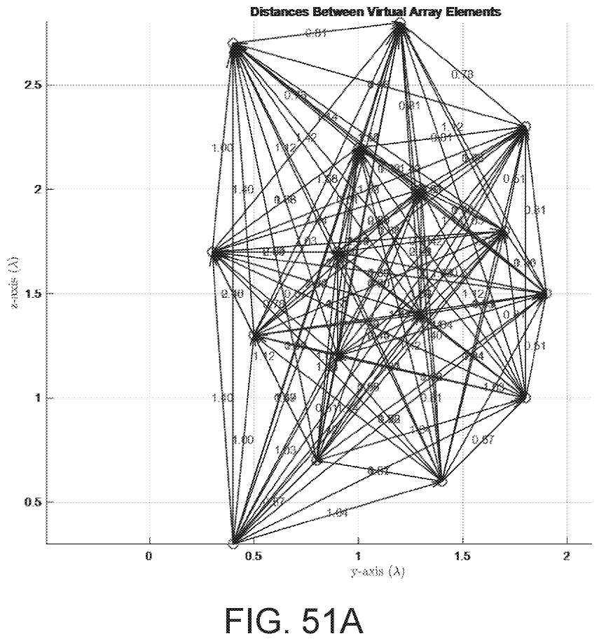

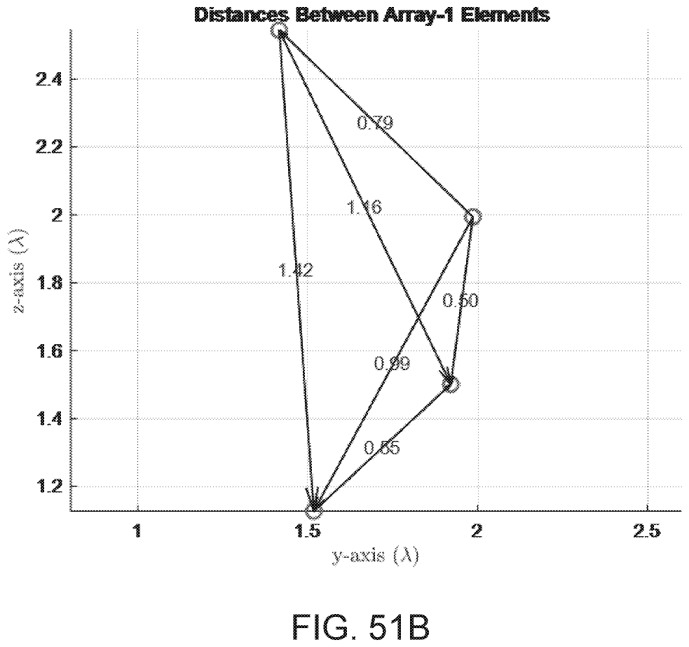

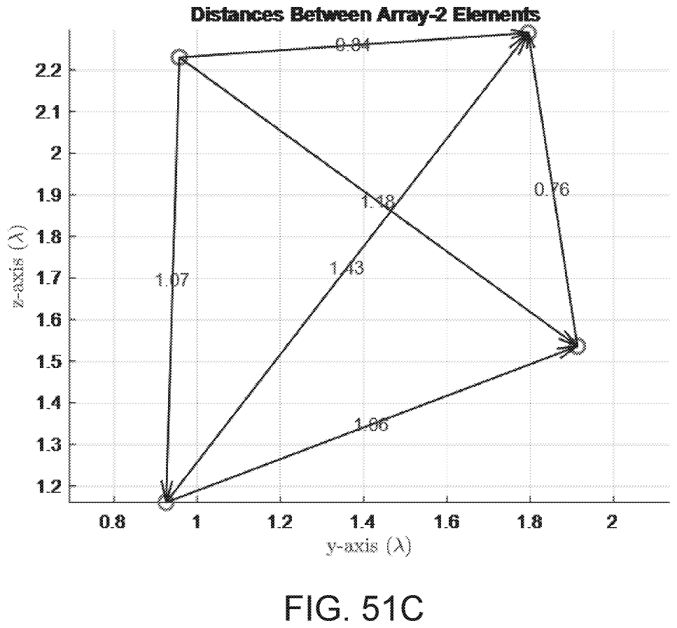

FIG. 51A shows a virtual array pattern in terms of distances between elements that are optimized or determined using a MOGA method with a finer grid for CPD operation. FIGS. 51B and 51C respectively show a first array and a second array in terms of distances between elements that are optimized or determined using the MOGA method with the finer grid for CPD operation.

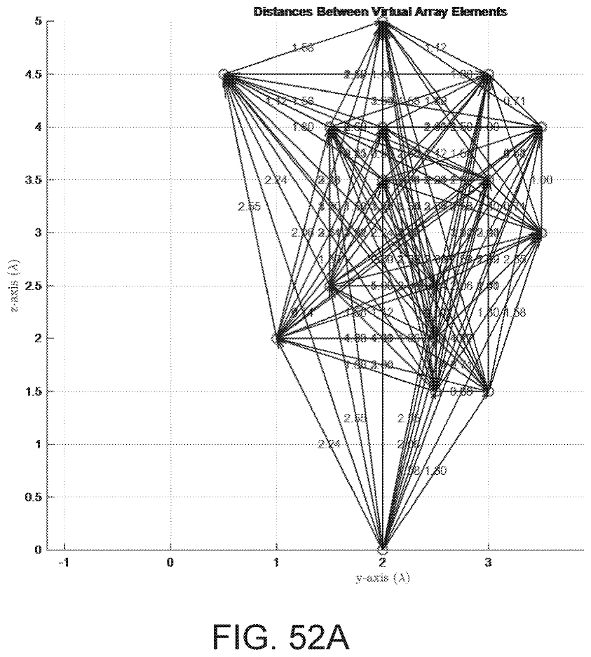

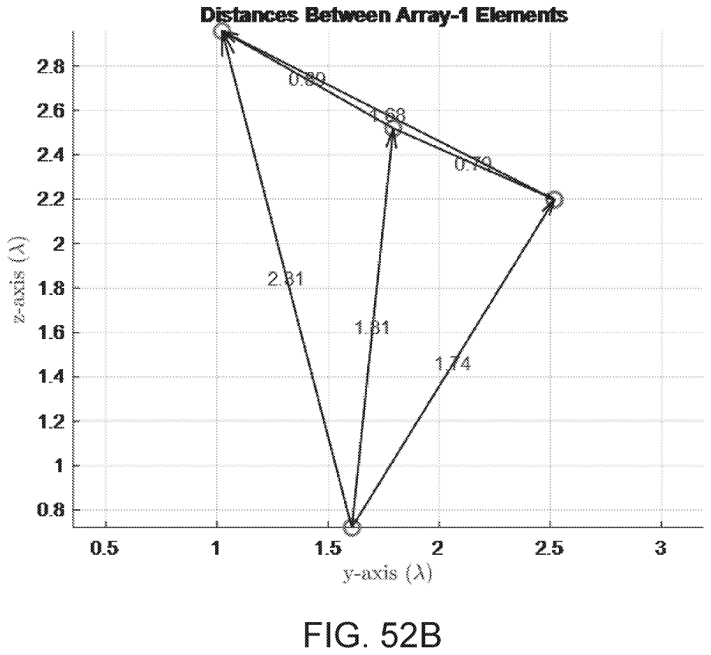

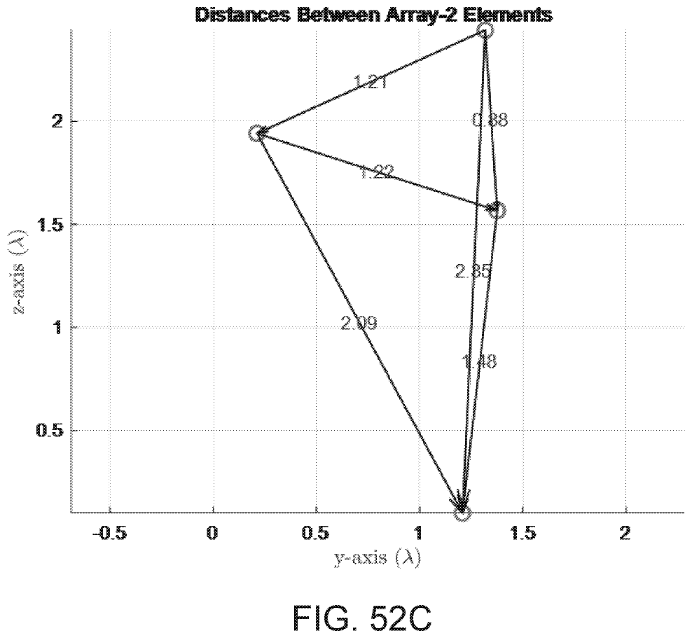

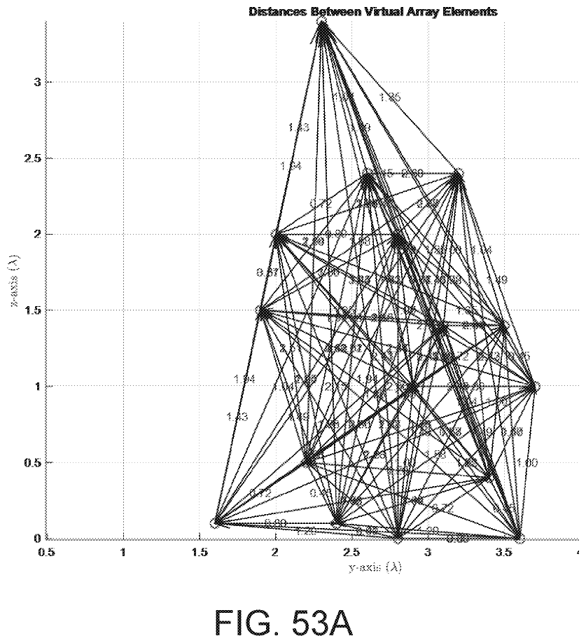

FIG. 52A shows a virtual array pattern in terms of distances between elements that are optimized or determined using a MOGA method with a finer grid for MOD operation. FIGS. 52B and 52C respectively show a first array and a second array in terms of distances between elements that are optimized or determined using the MOGA method with the finer grid for MOD operation.

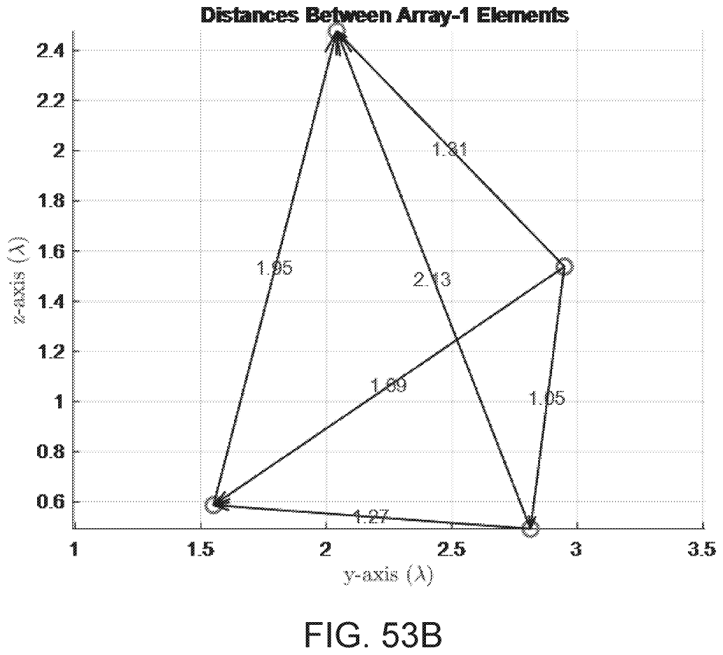

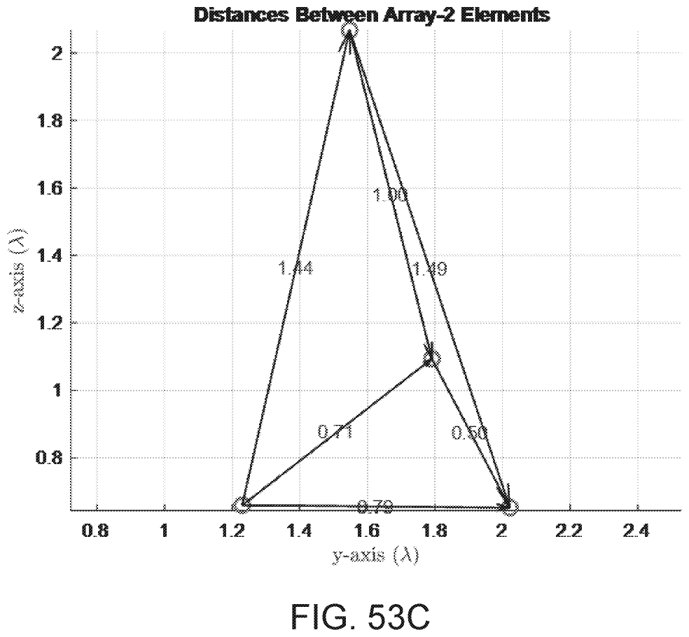

FIG. 53A shows a virtual array pattern in terms of distances between elements that are optimized or determined using a MOGA method with a finer grid for CPD-MOD operation. FIGS. 53B and 53C respectively show a first array and a second array in terms of distances between elements that are optimized or determined using the MOGA method with the finer grid for CPD-MOD operation.

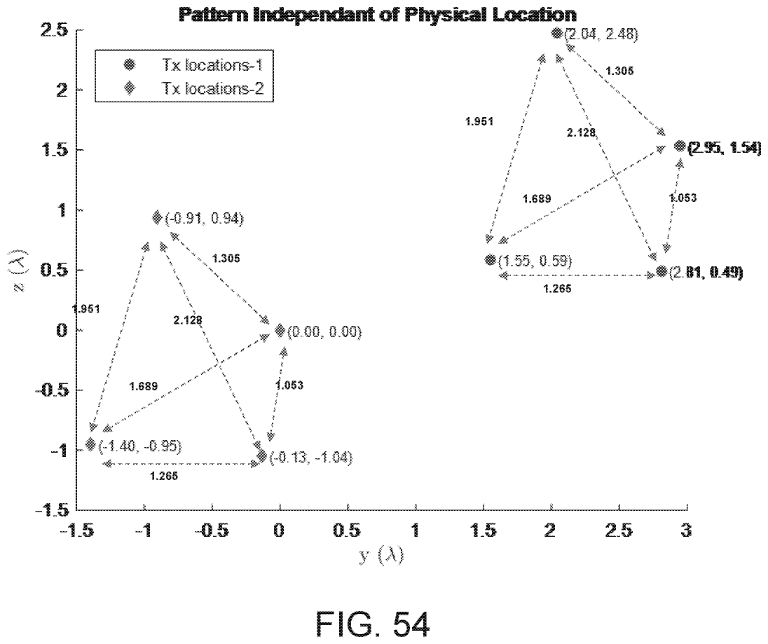

As shown in FIG. 54, a four transmitter pattern is described by the distances between all the transmitters and not by their physical placement on the hardware (e.g., a printed circuit board). For example, in the illustrated example, the four first Tₓ locations and the four second Tₓ locations are at different areas or regions on the physical hardware, but the patterns are the same as described by the distances between the elements. Thus, the system provides patterns for 12 virtual antennas, 4 transmitter antennas, and 4 receiver antennas. Interchanging the transmitter-receiver arrays does not change the virtual array.

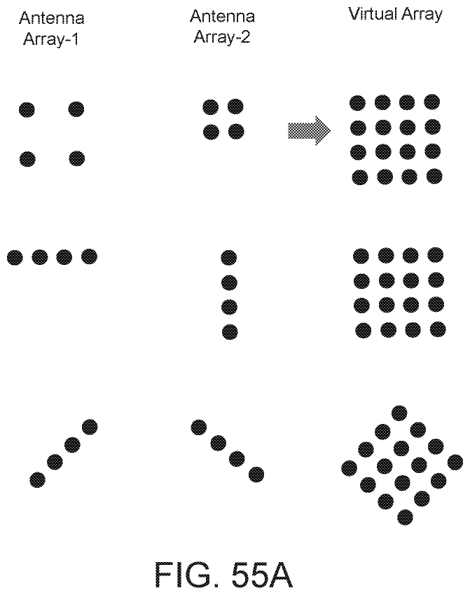

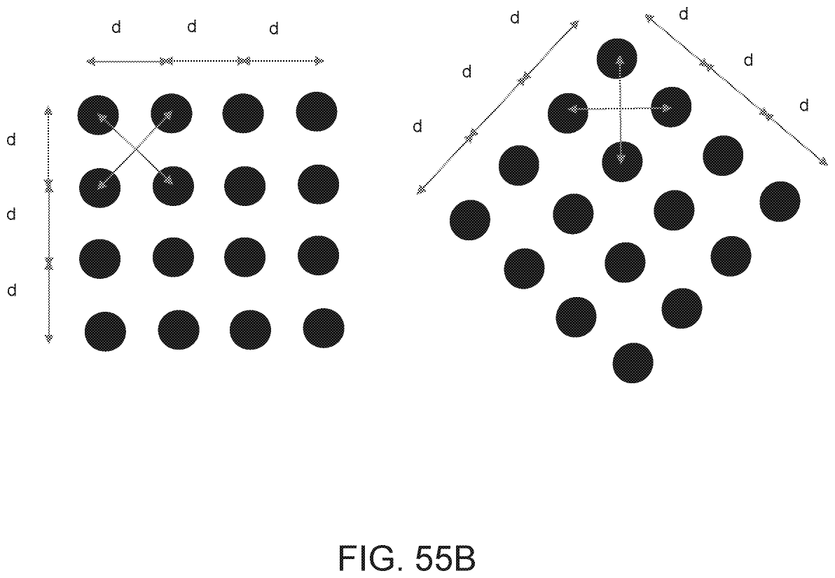

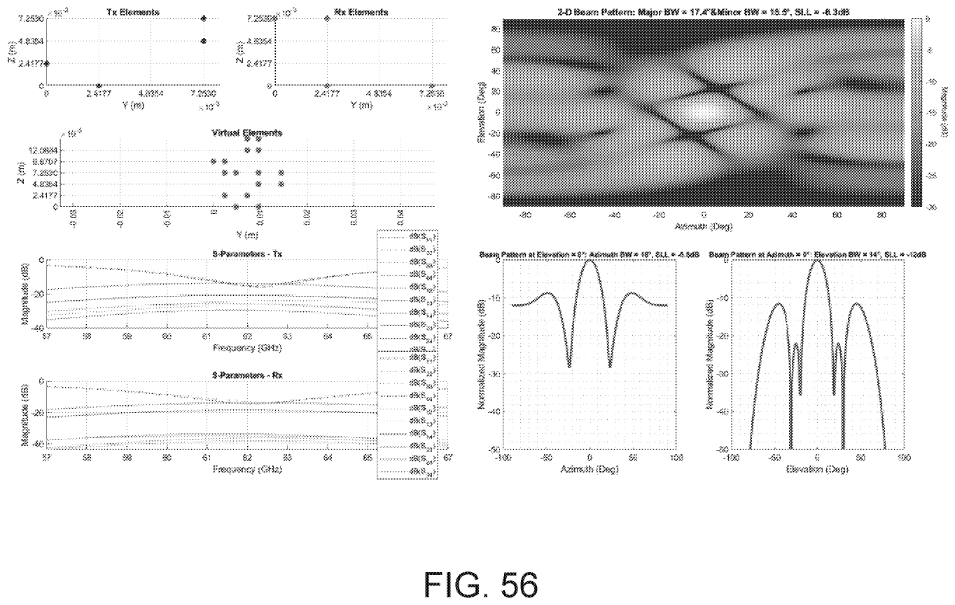

Multiple transmitter and receiver antenna may produce the same virtual array (FIGS. 55A and 55B). Rotated virtual arrays have the same constellation since the distance between all the combinations are the same. Interchanging transmitter and receiver arrays does not change the virtual array. That is, the virtual array and its rotated pattern have the same constellation since the distances between all combinations are the same. Thus, if transceiver and receiver antenna are established in a grid with individual antenna separated by lateral and longitudinal distances d, the diagonal distance between all adjacent virtual array elements would be \sqrt{2d}. Further, \sqrt{2d} is the horizontal and vertical distance between array elements when the antenna is rotated. For example, FIG. 56 shows that a rotated virtual array may have the same optimization parameters as FIGS. 25, 28 and 31. If skewness is included as a constraint in optimization, then a virtual rotated array cannot be considered.

Thus, for child protection detection (CPD), the system detects and reports a child left inside the vehicle and should have better SLL in the field of view or field of sensing. Major and minor beamwidth may be less important. The first example optimized antenna geometry of FIG. 32 may be used. For multi-occupant detection (MOD) the system detects and reports occupants in every seat of the vehicle and should have better major and minor resolution. SLL may be less important. The third example optimized antenna geometry of FIG. 36 may be used. For a combination of CPD and MOD, the system should have balanced performance with limited flexibility. The second example optimized antenna geometry of FIG. 34 may be used.

In case multiple layouts provide differing advantages, then strategies to combine the layouts may be considered. This may be achieved using additional antenna patches sharing common channels through switching networks and/or using reconfigurable arrays and/or electronically shifting the antennas without the need to physically move the antennas. An example is shown in FIG. 45. For example, the switchable arrays may utilize characteristics of arrays described in U.S. Pat. Nos. 5,294,939 and/or 11,835,645 and/or U.S. Pub. No. US-2025-0079700, which are incorporated herein by reference in their entireties.

Most of the parameters that relate to the objective function depend on the beam pattern. This in turn depends on the virtual array and the virtual array depends on the transmitter and receiver patterns. The exact location of the transmitter and receiver on the hardware (e.g., a printed circuit board) in not important but the pattern of virtual array, transmitter, and receiver matters (FIG. 54). In addition, multiple transmitter and receiver antenna array can produce the same virtual array. Furthermore, rotating the virtual array does not change the constellation or pattern since the distances between all the combinations are the same. However, if skewness of the main lobe is a constraint in the design and the major-minor axis needs to be aligned with hardware, then rotation of the virtual array may not be desired. It may be noted that interchanging transmitter and receiver array does not change the virtual array (FIGS. 55A and 55B). As an example, the results obtained in FIG. 19 can also be obtained as in FIG. 56.

The system thus may utilize sensors, such as radar sensors or imaging radar sensors, to detect presence of and/or range to objects. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving monitoring system of the vehicle or occupant monitoring system of the vehicle or cabin monitoring system of the vehicle or driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front or forward-sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward-viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

Changes and modifications in the specifically described embodiments can be carried out without departing from the principles of the invention, which is intended to be limited only by the scope of the appended claims, as interpreted according to the principles of patent law including the doctrine of equivalents.

1. A computer-implemented method for determining an optimized antenna layout for a vehicular cabin radar sensor, the method comprising:
receiving input constraints comprising a number of transmitter elements, a number of receiver elements, and a defined field of sensing;
defining a cost function based on at least one coverage parameter, wherein the at least one coverage parameter defines a sidelobe level (SLL) threshold across a plurality of non-boresight target locations within the defined field of sensing;
executing an automated optimization algorithm to determine spatial coordinates for the transmitter elements and the receiver elements, wherein the automated optimization algorithm is configured to minimize the cost function; and
generating a machine-readable hardware design specification for the vehicular cabin radar sensor, wherein the hardware design specification defines a physical placement of the transmitter elements and the receiver elements on a printed circuit board based on the determined spatial coordinates.

2. The computer-implemented method of claim 1, further comprising:
generating a virtual array pattern comprising virtual antenna elements corresponding to spatial combinations of the transmitter elements and the receiver elements, based on the determined spatial coordinates; and
validating the optimized antenna layout prior to generating the machine-readable hardware design specification by simulating a radar reflection based on the virtual array pattern.

3. The computer-implemented method of claim 2, wherein simulating the radar reflection comprises generating synthetic analog-to-digital converter (ADC) data simulating a frequency-modulated continuous wave (FMCW) radar reflection from a simulated target occupant, and wherein the synthetic ADC data is generated using a ground truth angle of arrival for the simulated target occupant.

4. The computer-implemented method of claim 3, wherein validating the optimized antenna layout further comprises:
processing the synthetic ADC data to extract an estimated angle of arrival for the simulated target occupant; and
comparing the estimated angle of arrival against the ground truth angle of arrival to determine an angle estimation error.

5. The computer-implemented method of claim 1, wherein receiving the input constraints further comprises receiving a discrete grid spacing based on an operating wavelength of the vehicular cabin radar sensor and a maximum available physical span, and wherein executing the automated optimization algorithm restricts the determined spatial coordinates to the discrete grid spacing and within the maximum available physical span without physical element overlap.

6. The computer-implemented method of claim 1, wherein executing the automated optimization algorithm comprises executing a multi-objective genetic algorithm (MOGA) to simultaneously optimize a plurality of conflicting objectives, the plurality of conflicting objectives comprising minimizing the cost function based on the at least one coverage parameter and minimizing an angular beamwidth of the vehicular cabin radar sensor.

7. The computer-implemented method of claim 1, wherein the cost function further evaluates a jitter parameter, and wherein evaluating the jitter parameter comprises simulating a random positional movement of at least one of the determined spatial coordinates within a bounding region to verify that the sidelobe level (SLL) threshold is maintained.

8. The computer-implemented method of claim 1, wherein executing the automated optimization algorithm comprises:
determining a first optimized antenna layout comprising a first set of spatial coordinates configured for a first sensing mode; and
determining a second optimized antenna layout comprising a second set of spatial coordinates configured for a second sensing mode.

9. The computer-implemented method of claim 8, wherein the machine-readable hardware design specification defines a switchable antenna array comprising a superset of the transmitter elements and the receiver elements, and wherein the switchable antenna array is configured to dynamically switch electronically between the first optimized antenna layout and the second optimized antenna layout.

10. The computer-implemented method of claim 8, wherein the first sensing mode is a child presence detection (CPD) mode wherein the automated optimization algorithm prioritizes minimizing the sidelobe level (SLL) threshold, and wherein the second sensing mode is a multi-occupant detection (MOD) mode wherein the automated optimization algorithm prioritizes minimizing an angular beamwidth.

11. A system for determining an optimized antenna layout for a vehicular cabin radar sensor, the system comprising:
at least one processor; and
at least one memory storing instructions that, when executed by the at least one processor, cause the at least one processor to perform operations comprising:
receiving input constraints comprising a number of transmitter elements, a number of receiver elements, and a defined field of sensing;
defining a cost function based on at least one coverage parameter, wherein the at least one coverage parameter defines a sidelobe level (SLL) threshold across a plurality of non-boresight target locations within the defined field of sensing;
executing an automated optimization algorithm to determine spatial coordinates for the transmitter elements and the receiver elements to minimize the cost function; and
generating a machine-readable hardware design specification for the vehicular cabin radar sensor, wherein the hardware design specification defines a physical placement of the transmitter elements and the receiver elements on a printed circuit board based on the determined spatial coordinates.

12. The system of claim 11, wherein the operations further comprise:
generating a virtual array pattern comprising virtual antenna elements corresponding to spatial combinations of the transmitter elements and the receiver elements, based on the determined spatial coordinates; and
validating the optimized antenna layout prior to generating the machine-readable hardware design specification by simulating a radar reflection based on the virtual array pattern.

13. The system of claim 12, wherein the operations further comprise generating synthetic analog-to-digital converter (ADC) data simulating a frequency-modulated continuous wave (FMCW) radar reflection from a simulated target occupant, and wherein the synthetic ADC data is generated using a ground truth angle of arrival for the simulated target occupant.

14. The system of claim 13, wherein the operations further comprise:
processing the synthetic ADC data to extract an estimated angle of arrival for the simulated target occupant; and
comparing the estimated angle of arrival against the ground truth angle of arrival to determine an angle estimation error.

15. The system of claim 11, wherein the operations further comprise:
receiving a discrete grid spacing based on an operating wavelength of the vehicular cabin radar sensor and a maximum available physical span; and
restricting the determined spatial coordinates to the discrete grid spacing and within the maximum available physical span without physical element overlap.

16. The system of claim 11, wherein the operations further comprise executing a multi-objective genetic algorithm (MOGA) to simultaneously optimize a plurality of conflicting objectives, the plurality of conflicting objectives comprising minimizing the cost function based on the at least one coverage parameter and minimizing an angular beamwidth of the vehicular cabin radar sensor.

17. The system of claim 11, wherein the cost function further evaluates a jitter parameter, and wherein to evaluate the jitter parameter, the operations further comprise simulating a random positional movement of at least one of the determined spatial coordinates within a bounding region to verify that the sidelobe level (SLL) threshold is maintained.

18. The system of claim 11, wherein the operations further comprise:
determining a first optimized antenna layout comprising a first set of spatial coordinates configured for a first sensing mode; and
determining a second optimized antenna layout comprising a second set of spatial coordinates configured for a second sensing mode.

19. The system of claim 18, wherein the machine-readable hardware design specification defines a switchable antenna array comprising a superset of the transmitter elements and the receiver elements, and wherein the switchable antenna array is configured to dynamically switch electronically between the first optimized antenna layout and the second optimized antenna layout.

20. A vehicular cabin monitoring system comprising:
a radar sensor configured to be disposed at an interior cabin of a vehicle, the radar sensor comprising an antenna array having a plurality of transmitter elements and a plurality of receiver elements disposed on a printed circuit board; and
an electronic control unit (ECU) in communication with the radar sensor, wherein the ECU is configured to:
operate the radar sensor in a first sensing mode to perform a child presence detection (CPD) function; and
operate the radar sensor in a second sensing mode to perform a multi-occupant detection (MOD) function,
wherein the antenna array is a switchable antenna array comprising a superset of the transmitter elements and the receiver elements, and wherein the ECU is configured to dynamically switch between a first antenna layout for the first sensing mode and a second antenna layout for the second sensing mode.
